(19) United States
(12) Patent Application Publication
(10) Pub. No.: US 2026/0290071 A1
(43) Pub. Date: Sep. 24, 2026

(54) SYSTEM

(71) Applicant: SoftBank Group Corp., Tokyo (JP)

(72) Inventor: Makoto YOSHIDA, Tokyo (JP)

(73) Assignee: SoftBank Group Corp., Tokyo (JP)

(21) Appl. No.: 19/560,369

(22) Filed: Mar. 9, 2026

(30) Foreign Application Priority Data
Mar. 19, 2025 (JP) 2025-044906

(51) Int. Cl. G06V 40/16; G06N 3/0475; G06N 3/048

(52) U.S. Cl. CPC G06V 40/165; G06N 3/0475; G06N 3/048; G06V 40/172

(57) ABSTRACT

A system includes a processor that is configured to upload a soccer match video, automatically analyze and collect team-specific data and player-specific data from the uploaded video, analyze a performance of a player based on the collected data, and generate a prompt for instructing a generative AI model to provide a proposal for improvement based on the analyzed performance.

### CROSS-REFERENCE TO RELATED APPLICATION

This application is based on and claims priority under 35 USC 119 from Japanese Patent Application No. 2025-044906 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional coaching support systems for soccer rely heavily on subjective evaluations by coaches and parents and are not capable of consistently generating objective, individualized feedback for each player. Existing video analysis tools may provide basic statistics such as total running distance or number of passes, but they generally do not automatically integrate these statistics with player condition data, emotional state, and advanced generative AI to produce concrete and personalized improvement proposals. In addition, even when performance data is available, the burden is placed on the coach or user to interpret the data and to design appropriate training plans and nutrition strategies, which requires specialized knowledge and significant time. Furthermore, current systems do not sufficiently leverage emotion recognition to adapt feedback and analysis according to a user's emotional state, which can influence the effectiveness of guidance and motivation. Therefore, there is a need for a system that automatically uploads and analyzes soccer match videos, generates prompts that instruct a generative AI model to produce improvement proposals based on player performance, and further generates prompts for customized training plans, nutrition advice, and feedback tailored to the user's emotional state, thereby enabling objective and efficient support for player development.

### SUMMARY

In order to solve the above-described problems, the present invention provides a system comprising a processor, wherein the processor is configured to upload a soccer match video, automatically analyze and collect team-specific data and player-specific data from the uploaded video, analyze a performance of a player based on the collected data, and generate a prompt for instructing a generative AI model to provide a proposal for improvement based on the analyzed performance. The processor is further configured to monitor a condition of the player, such as physical condition, fatigue level, or injury information, and to generate a prompt for instructing the generative AI model to provide a customized training plan and nutrition advice based on the monitored condition. Moreover, the processor is configured to use an emotion engine to recognize a user emotion and collect emotion data, and to generate a prompt for instructing the generative AI model to perform the performance analysis and provide the proposal for improvement based on the collected emotion data. By generating and supplying such prompts to the generative AI model, the system can automatically produce individualized improvement proposals, adaptive training plans, and tailored nutrition advice, as well as emotionally appropriate feedback, thereby enabling objective, efficient, and personalized support for soccer player development.

The term “system” refers to an arrangement comprising at least one processor and, optionally, one or more memories, input/output interfaces, communication interfaces, storage devices, and software modules configured to perform the functions described in the claims. The term “processor” refers to any hardware device or combination of devices capable of executing instructions, including but not limited to a central processing unit (CPU), a graphics processing unit (GPU), an application specific integrated circuit (ASIC), a field programmable gate array (FPGA), or a microcontroller.

The term “soccer match video” refers to digital video data representing at least a part of a soccer game, the video including images of players, a ball, and a field, and being encoded in any suitable digital format.

The term “upload” refers to transmitting the soccer match video from a terminal or local storage to the system or to a server associated with the system over a wired or wireless communication network.

The term “team-specific data” refers to data derived from the uploaded soccer match video that is associated with a team as a whole, including but not limited to team formation, possession statistics, number of shots, passes, goals, and other collective performance indicators.

The term “player-specific data” refers to data derived from the uploaded soccer match video that is associated with an individual player, including but not limited to running distance, speed, number of sprints, pass attempts, successful passes, shots, positions on the field, and other individual performance metrics.

The term “automatically analyze and collect” refers to performing processing by the processor without requiring manual intervention for each operation, the processing including detecting players and the ball, tracking their movements, extracting events, and computing team-specific data and player-specific data from the uploaded soccer match video.

The term “performance of a player” refers to a quantitative and/or qualitative evaluation of actions and behavior of an individual player during the soccer match, based on the player-specific data and optionally on the team-specific data.

The term “generative AI model” refers to a machine learning model that is configured to generate content such as text, recommendations, or other outputs in response to input data or prompts, and that may be implemented, for example, as a large language model, a transformer-based model, or another generative neural network.

The term “prompt” refers to information generated by the processor and supplied as input to the generative AI model, the information specifying one or more instructions, constraints, contexts, or questions that guide the generative AI model in producing an output such as a proposal for improvement, a training plan, or nutrition advice.

The term “proposal for improvement” refers to information generated, based on the output of the generative AI model, that suggests one or more actions, strategies, or points of focus intended to enhance the performance of a player or a team.

The term “monitor a condition of the player” refers to obtaining and updating data representing a physical, physiological, or contextual state of the player, including but not limited to fatigue level, injury status, training load, body weight, height, or health-related information.

The term “customized training plan” refers to a set of training contents generated based on the condition of the player and the performance of the player, the training contents including, for example, exercises, drills, frequency, duration, and intensity, and being adapted to the individual characteristics and needs of the player.

The term “nutrition advice” refers to recommendations concerning intake of food, beverages, or nutrients in relation to the player, including but not limited to timing, type, and quantity of macronutrients or micronutrients before, during, or after training or matches.

The term “emotion engine” refers to a software and/or hardware component configured to detect, infer, or recognize an emotional state of a user, based on one or more inputs such as voice, facial expression, physiological signals, text, or interaction patterns.

The term “user emotion” refers to an emotional state of a user, such as happiness, frustration, motivation, anxiety, or satisfaction, as recognized or inferred by the emotion engine.

The term “emotion data” refers to data representing at least one aspect of the user emotion, including but not limited to emotion type, intensity, duration, or temporal changes in the emotional state.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

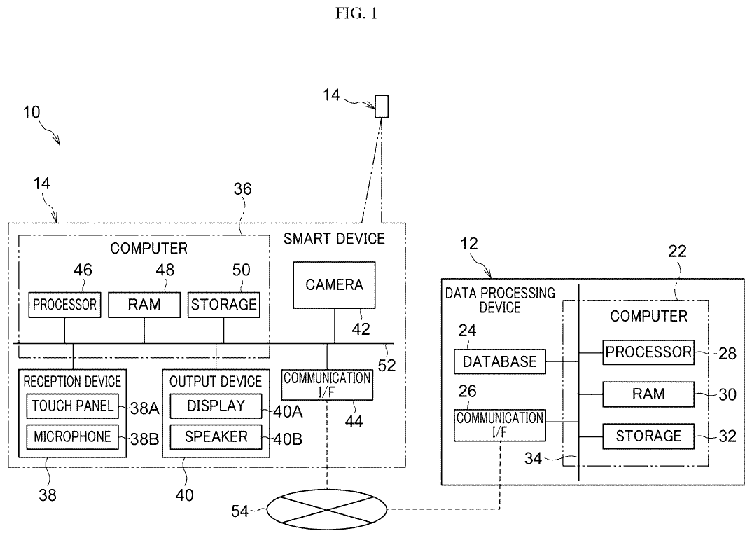

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

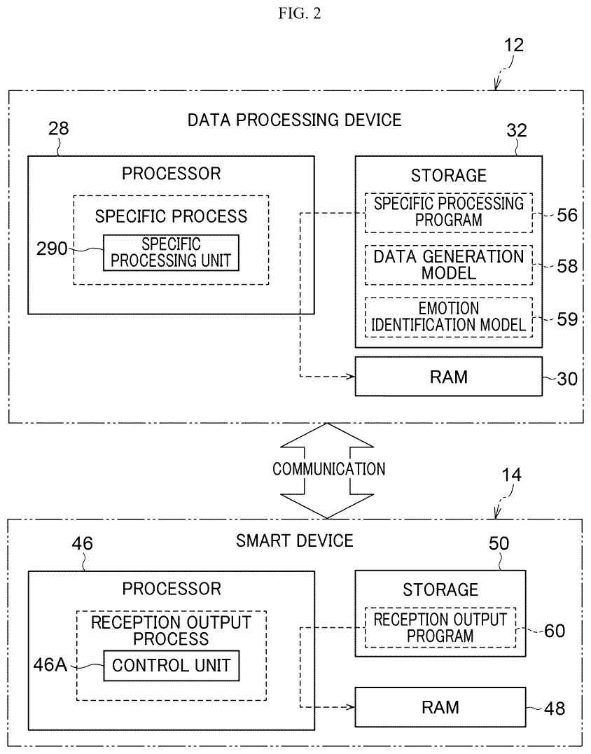

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional systems for analyzing sports performance from match videos typically rely on separate, loosely coupled components for video processing, metric computation, and generation of coaching advice. In such systems, a server may decode video frames and extract basic statistics, while a human expert or a manually crafted rule engine interprets the statistics and drafts training advice. This architecture suffers from several technical problems. First, conventional systems do not tightly integrate frame-level detection and tracking of multiple subjects with downstream machine learning-based evaluation and automated text generation. Video analysis modules often output coarse or aggregated values that are not preserved as structured, time-series data suitable for direct consumption by machine learning models and generative models. As a result, significant manual preprocessing and reformatting are required, increasing latency, consuming computational resources inefficiently, and creating opportunities for data loss or inconsistency.
Second, existing systems generally treat generative AI models as standalone text generators that respond only to free-form user instructions. These systems do not provide a standardized mechanism for automatically constructing prompt sentences that consistently embed rich, machine-computed context, such as per-subject motion indices, ability evaluation scores, and temporal performance trends. Without this structured prompt generation, the generative AI model cannot systematically exploit the underlying numerical data, leading to unstable output quality, reduced reproducibility, and difficulty in verifying or auditing produced guidance. Third, conventional solutions do not provide a unified pipeline in which a processor automatically transforms raw moving image data into (i) high-resolution motion index data, (ii) model-based ability evaluation information, and then (iii) context-aware prompt sentences adapted to state information of each subject and emotional state information of a user. Instead, these steps are often implemented as disjoint processes, involving multiple data formats and manual integration, which degrades system robustness, complicates error handling, and impedes real-time or near real-time operation.

Fourth, known systems typically do not adapt the mode and content of generated feedback based on user-specific factors such as emotional state, workload, or recent interaction patterns. The lack of such adaptive behavior leads to a one-size-fits-all presentation that may overload users with information or provide advice that is poorly timed or perceived as insensitive, thereby reducing the effectiveness of the system as an interactive analytical and coaching tool.
Accordingly, there is a need for an improved computer-implemented system and server-side processing pipeline that: (i) automatically converts high-volume moving image data into structured motion index data and ability evaluation information using machine learning models, (ii) automatically constructs prompt sentences for a generative AI model by embedding this structured context together with user-provided instructions, (iii) incorporates state information of each subject and emotional state information of a user into the prompt construction process, and (iv) generates and delivers adaptive training plans, tactical advice, and nutrition guidance in a format directly consumable by terminal devices. Such a system would improve the efficiency, reliability, and technical performance of computer-based video analysis and AI-driven feedback generation.

The specific processing by the specific processing unit 290 of the data processing device 12 in Example 1 is realized by the following means.

The present invention provides a server comprising a processor and a storage device, the processor being configured to execute an integrated processing pipeline that receives moving image data of a sports match from a terminal, stores the moving image data in the storage device, decodes the moving image data into frames, applies an image processing program to detect multiple subjects on a frame-by-frame basis, tracks the subjects over time to generate time-series position data for each subject, and computes group-level and individual-level motion index data including movement distance, speed, sprint count, and region-wise stay distribution. The processor is further configured to input the motion index data into a machine learning model to perform inference and thereby generate ability evaluation information for each subject, the ability evaluation information including at least endurance, speed, workload, and tactical contribution, to generate analysis context information as document data or structured data including feature data, evaluation scores, and temporal changes for each subject based on the motion index data and the ability evaluation information, to acquire state information of each subject obtained from biological information, exercise load information, or performance indices per match, and to add the state information to the analysis context information. The processor is also configured to acquire emotional state information of a user calculated from at least one of voice input, facial expression information, or operation history, to associate the emotional state information with the analysis context information, and to combine the analysis context information, the state information, and user-provided text input including instruction content relating to coaching or analysis into instruction sentence data formatted as a prompt sentence for input to a generative AI model. The processor is further configured to transmit the instruction sentence data to the generative AI model, to receive from the generative AI model improvement proposal information including a training plan, tactical advice, and nutrition guidance generated on the basis of the motion index data, the ability evaluation information, the state information, and the emotional state information, to convert the improvement proposal information into display data divided for each subject or group, and to transmit the display data to the terminal. This enables a computer-implemented improvement in which raw moving image data is automatically transformed, within a unified server-side processing architecture, into structured motion index data, model-based ability evaluation information, and context-aware prompt sentences for a generative AI model, thereby reducing manual data handling, improving the consistency and relevance of generated guidance, adapting the content and presentation of feedback to both subject state and user emotional state, and enhancing the overall efficiency and technical performance of the video analysis and AI-driven recommendation system.

The term “moving image data” refers to digital data representing a time-sequential series of images, including but not limited to video data of a sports match composed of multiple frames encoded in a compressed or uncompressed format.
The term “terminal” refers to an electronic apparatus operated by a user and configured to capture, store, upload, receive, or display data, such as a mobile device, a tablet device, a personal computer, or any other client device capable of network communication with a server.
The term “storage device” refers to a hardware component or a combination of hardware components configured to store digital data persistently or semi-persistently, including but not limited to a semiconductor memory, a magnetic storage medium, or an optical storage medium.
The term “image processing program” refers to software executed by a processor that performs operations on image data or moving image data, such as decoding, frame extraction, object detection, tracking, feature extraction, or other computer-vision-related processing.
The term “subject” refers to an object of interest detected in the moving image data, including but not limited to a player, an official, or any other entity whose motion, position, or behavior is to be analyzed.
The term “time-series data of position information” refers to data representing chronological changes in position of a subject, including a sequence of coordinates or location values associated with time indices or frame indices.
The term “motion index data” refers to quantitative data derived from the time-series data of position information, including at least movement distance, speed, sprint count, and region-wise stay distribution, for each subject or group of subjects.
The term “group-level motion index data” refers to motion index data that is aggregated or computed for a plurality of subjects considered as a collective entity, such as a team, a formation, or a positional unit.
The term “individual-level motion index data” refers to motion index data that is calculated for each subject independently, representing individual movement characteristics or performance indicators.
The term “movement distance” refers to a value representing a length of a path traveled by a subject over a period of time, computed from changes in the subject's position information.
The term “speed” refers to a value representing a rate of change of the position of a subject with respect to time, which may be calculated on a per-frame basis or over a time interval.
The term “sprint count” refers to a value representing a number of time intervals during which the speed of a subject exceeds a predetermined speed threshold for at least a predetermined duration.
The term “region-wise stay distribution” refers to data representing how long or how frequently a subject remains within defined spatial regions of a field or area, derived from the subject's position information.
The term “machine learning model” refers to a computational model created through a training process using training data, configured to perform inference tasks such as classification, regression, scoring, or other predictive or analytical operations based on input data.
The term “ability evaluation information” refers to information indicating estimated capabilities or performance characteristics of a subject, including at least endurance, speed, workload, and tactical contribution, derived by applying a machine learning model to motion index data.
The term “endurance” refers to an indicator within the ability evaluation information that represents a subject's capacity to sustain physical activity over time, inferred from motion index data such as total distance, high-intensity distance, or temporal performance patterns.
The term “workload” refers to an indicator within the ability evaluation information that represents an overall volume or intensity of physical activity performed by a subject, which may include aggregated distance, number of high-intensity actions, or similar metrics.
The term “tactical contribution” refers to an indicator within the ability evaluation information that represents a subject's contribution to team tactics or strategy, inferred from spatial positioning, movement patterns, or interaction with other subjects.
The term “analysis context information” refers to document data or structured data representing a comprehensive analytical summary for each subject, including at least motion index data, ability evaluation information, feature data, evaluation scores, and temporal changes.
The term “feature data” refers to a set of numerical or categorical values derived from raw data, motion index data, or other sources, formatted as inputs suitable for a machine learning model or for use in generating analysis context information.
The term “evaluation score” refers to a numerical or categorical value indicating a result of evaluation of a subject's ability or performance, which may be produced by a machine learning model or by post-processing of model outputs.

The term “temporal changes” refers to variations or trends in motion index data, ability evaluation information, or evaluation scores over time, including changes between different time segments within a match or across multiple matches.
The term “state information” refers to information indicating a condition of a subject, obtained from at least one of biological information, exercise load information, or performance indices per match, and may include fatigue level, recovery status, or other physiological or performance-related indicators.
The term “biological information” refers to data related to a physiological state of a subject, including but not limited to heart rate, heart rate variability, body temperature, or similar biometric measurements.
The term “exercise load information” refers to data indicating a physical load or training stress applied to a subject, including but not limited to training duration, intensity, frequency, or session-based workload indices.
The term “performance indices per match” refers to numerical indicators representing a subject's performance in an individual match, including motion index data, event-based statistics, or other match-specific performance measurements.
The term “emotional state information” refers to information indicating an inferred emotional condition of a user, calculated from at least one of voice input, facial expression information, or operation history.
The term “voice input” refers to audio data captured from a user's spoken utterances and processed by a computing device for purposes such as speech recognition or emotion estimation.
The term “facial expression information” refers to data derived from images or video of a user's face, representing detected facial features or expressions used to infer an emotional state.
The term “operation history” refers to data representing a sequence of user interactions with a terminal or a system, including inputs, selections, navigation patterns, or timing information.
The term “analysis context information associated with emotional state information” refers to analysis context information that is linked or combined with emotional state information, enabling adaptation of feedback content or presentation based on a user's emotional condition.
The term “text input including instruction content” refers to a text string provided by a user or system, describing a request, constraint, or guideline relating to analysis, coaching, training planning, or feedback generation.
The term “instruction sentence data” refers to data representing a text sequence formatted as a prompt sentence, including at least analysis context information and instruction content, and intended to be input to a generative AI model.
The term “prompt sentence” refers to a text-based instruction or query input to a generative AI model, guiding the generative AI model to produce output relevant to the embedded context and requested task.
The term “generative AI model” refers to a computational model that generates text or other content in response to input data, such as a language model trained on large-scale data, and configured to output improvement proposals or guidance based on provided prompt sentences.
The term “improvement proposal information” refers to information generated by the generative AI model that includes at least a training plan, tactical advice, and nutrition guidance intended to improve performance or condition of a subject.
The term “training plan” refers to a structured set of physical training activities, schedules, or programs specifying at least a period, a frequency, and an intensity for exercises or sessions for a subject.
The term “tactical advice” refers to recommendations regarding positioning, movement patterns, decision-making, or coordination with other subjects, intended to improve strategic or tactical performance.
The term “nutrition guidance” refers to recommendations relating to dietary intake, including types, amounts, and timing of nutrients, designed to support performance, recovery, or overall health of a subject.
The term “display data” refers to data formatted for presentation on a terminal, including text, numerical tables, or graphical elements, derived from improvement proposal information and divided for each subject or group.
The term “server” refers to a computing apparatus or a group of computing apparatuses including at least one processor and a storage device, configured to perform data reception, analysis, model inference, prompt generation, and result distribution in communication with one or more terminals.
The term “processor” refers to a hardware execution unit or a combination of hardware execution units, such as a central processing unit or a graphics processing unit, configured to execute instructions of programs implementing the functions described in the system.

In one embodiment, a server cooperates with one or more terminals to implement a system that analyzes moving image data of a sports match and generates adaptive improvement proposals using a generative AI model. The server includes at least one processor, a main memory, a non-volatile storage device such as a solid-state drive, and a network interface. The terminal includes at least one processor, a memory, a display device, a user input device, and a network interface. The server and the terminal are connected via a communication network such as the Internet, a wireless network, or a local area network. The terminal executes an application, such as a web browser or a native mobile application, that enables a user to select a video file storing moving image data of a soccer match and upload the video file to the server. The terminal converts user operations, such as a file selection and a button press, into a network request, and transmits the video file and associated metadata to the server by using a secure communication protocol such as HTTPS. The terminal also displays analysis results, including motion index data, ability evaluation information, and improvement proposal information, received from the server in a human-readable format such as text, tables, and graphical charts.
The server executes server-side software implemented in a general-purpose programming language, such as a scripting language or a compiled language, together with specialized libraries including a video processing library (e.g., a computer vision library such as OpenCV), a numerical computation library (e.g., a matrix operation library), and a machine learning framework (e.g., a neural network framework such as TensorFlow or PyTorch). The server stores uploaded moving image data in the storage device as one or more video files and records metadata in a database management system, such as a relational database, in which tables store information about matches, subjects, metrics, and generated recommendations.
The server uses a video processing library to decode the moving image data into individual frames and to convert each frame into a numerical matrix representation of pixel values. The server uses an object detection model, such as a convolutional neural network implementing a single-shot or multi-stage detection architecture, to detect subjects in each frame. The server uses a tracking algorithm, such as a data association algorithm combined with Kalman filtering and appearance feature embedding, to assign persistent identifiers to subjects across frames and to generate time-series data of position information for each subject. The server stores the time-series position information as sequences of coordinates indexed by a frame index or a timestamp in a database table or a structured file format.
The server computes motion index data from the time-series position information. The server calculates movement distance for each subject by summing Euclidean distances between successive position coordinates and applying a scale factor that converts pixel distances to real-world distances. The server calculates speed values by dividing per-frame distance by time intervals derived from the frame rate. The server determines a sprint count by counting contiguous intervals in which the speed exceeds a predefined threshold speed for at least a predefined duration. The server computes region-wise stay distribution by mapping positions to predefined spatial regions on the field and computing cumulative time or frequency of presence in each region. The server stores group-level aggregations, such as average movement distance per team or total sprint count, and individual-level motion index data in database structures optimized for analytical queries.
The server uses a machine learning model implemented in a machine learning framework to generate ability evaluation information from the motion index data. In one embodiment, the machine learning model is a multi-layer neural network that receives, as input features, normalized numerical values representing movement distance, high-intensity distance, sprint count, maximum speed, speed variability, region-wise occupancy ratios, and temporal patterns such as segment-wise metrics per time block. The server normalizes the input features by applying a scaling method, such as z-score normalization, and organizes the features into a fixed-length tensor. The server passes the tensor through layers of linear transformations and nonlinear activation functions, such as rectified linear units, to compute hidden representations. The server produces output values including endurance scores, speed scores, workload scores, and tactical contribution scores.
The server trains the machine learning model in advance on a training dataset containing historical motion index data and ground-truth labels or expert evaluations. During training, the server uses a loss function, such as mean squared error or cross-entropy, to measure the discrepancy between model outputs and target labels. The server updates model parameters by using an optimization algorithm, such as stochastic gradient descent or a variant thereof, and applies regularization or early stopping techniques to prevent overfitting. The server may use data augmentation at the feature level, such as noise injection or temporal resampling, to improve robustness of the model. Once trained, the server loads the model parameters into memory and applies inference to new motion index data in real time or near real time. The server generates analysis context information that combines the motion index data and the ability evaluation information into a structured representation. The server creates, for each subject, a record or document that includes feature data, evaluation scores, motion index summaries, and indicators of temporal changes, such as differences between halves of a match or trends across multiple matches. The server may store this analysis context information in a document database or a structured table, enabling efficient retrieval and reuse when constructing prompt sentences for a generative AI model.
The server acquires state information of each subject from additional data sources. The server may receive biological information, such as heart rate or body temperature, from external sensors through an application programming interface. The server may compute exercise load information, such as session-level workload indices, based on training logs or repeated match data. The server may calculate performance indices per match from event logs or extended statistics. The server integrates this state information into the analysis context information, for example by adding fields representing fatigue level, recovery status, or risk of overtraining.
The server acquires emotional state information of a user to adapt the presentation of results. The server may receive voice input recorded by the terminal, process the audio with a speech analysis module that computes acoustic features such as pitch, energy, and spectral coefficients, and infer an emotional state category based on a classifier model. The server may receive facial expression information captured by a camera of the terminal, extract facial landmarks or expression features, and estimate an emotional label such as frustration or satisfaction. The server may analyze operation history, such as rapid navigation patterns or repeated requests for clarification, to derive indicators of stress or confusion. The server associates the emotional state information with the analysis context information and stores the association in the database.
The server generates instruction sentence data formatted as a prompt sentence for a generative AI model. The server constructs a base text template that describes the role of the generative AI model and the type of output required. The server inserts selected elements of the analysis context information and state information into the template, such as numerical metrics, categorical labels, and a concise description of strengths and weaknesses. The server then appends user-provided text input that expresses specific instructions or constraints. As a result, the server forms a prompt sentence that systematically embeds machine-computed context and user intent.
The server enables the user to input prompt sentences via the terminal. The user may type, for example, “Analyze the running distance and sprint count of each player and propose a four-week stamina training plan.” The server parses this text input and classifies it as a request for stamina-focused training guidance. The server combines this instruction with the motion index data and ability evaluation information relevant to stamina and generates a refined prompt sentence that includes both the user's text and the structured metrics. The server may also generate prompt sentences such as “Based on the positional data and sprint patterns of the central midfielder, propose drills to improve off-the-ball movement and short-distance acceleration,” or “Using the match workload and recent performance decline, suggest a weekly schedule that balances recovery and performance, including specific nutrition recommendations.”
The server interacts with a generative AI model that implements a language model architecture, such as a transformer-based neural network trained on large-scale text data and fine-tuned on domain-specific instructions. The server transmits the prompt sentence to the generative AI model via an application programming interface, specifying parameters such as maximum output length, sampling temperature, or top-k sampling threshold to control output characteristics. The generative AI model receives the prompt sentence as a sequence of token embeddings, propagates the embeddings through multiple self-attention and feedforward layers, and computes probability distributions over output tokens. The model generates natural-language sequences that express recommendations tailored to the embedded metrics and instructions.
The server post-processes the output of the generative AI model to form improvement proposal information. The server segments the generated text into sections representing a training plan, tactical advice, and nutrition guidance. The server applies parsing rules or pattern-matching techniques to identify elements such as session dates, exercise types, durations, and intensities. The server assigns metadata linking each recommendation to a particular subject, match, or time period. The server formats the improvement proposal information into display data suitable for rendering on the terminal, for example by generating a structured markup document.
The server achieves a technical improvement over conventional systems by tightly integrating the video processing pipeline, the machine learning model for ability evaluation, and the generative AI model prompt construction in a single, coherent data flow. The server reduces conversion overhead and loss of granularity by preserving frame-level and time-series data and by directly feeding rich motion index data into the machine learning model and the generative AI model prompts. This integration enables the server to generate more accurate and stable recommendations with reduced latency and reduced computational redundancy.
The server improves computational efficiency by using optimized numerical libraries, hardware acceleration through graphics processing units for both video analysis and neural network inference, and data structures that minimize repeated disk input/output. The server reduces communication load between the server and the terminal by transmitting only derived metrics and formatted recommendations instead of raw video data once the initial upload is complete. The server improves data management by storing intermediate representations—such as time-series position data, normalized feature tensors, and analysis context documents—in normalized and indexable forms, enabling rapid retrieval and incremental updates.
The server improves accuracy and robustness of analysis compared to manual or rule-based systems. The machine learning model can capture complex, non-linear relationships between motion index data and ability evaluation information that are difficult to encode in hand-crafted rules. The generative AI model, when provided with systematically structured prompt sentences, can generate context-aware guidance that is aligned with the computed metrics in a reproducible and auditable way. The server can log prompt sentences and model outputs, allowing verification and refinement of both the model and the prompt construction logic. The server uses processing rules and workflows that are not equivalent to a simple automation of human judgment. The server applies specific algorithms, such as multi-object tracking with probabilistic state estimation, neural network-based inference using high-dimensional feature vectors, and transformer-based text generation conditioned on structured context. These algorithms operate based on mathematical optimization and data-driven learning methods, such as gradient-based weight updates and loss minimization, which differ fundamentally from intuitive human reasoning. The server can adjust thresholds, feature sets, and model architectures to optimize for latency and accuracy under computational constraints, a tuning process that inherently leverages the capabilities of computing hardware and software.
The server can be implemented in various alternative configurations. In one variation, the server uses a different object detection architecture, such as a multi-stage region-based detector, while still generating time-series position data suitable for motion index computation. In another variation, the server employs a recurrent neural network or a temporal convolutional network as the machine learning model to explicitly model temporal dependencies in motion index data. In yet another variation, the server deploys the generative AI model within the same computing environment instead of accessing a remote model via an external service, enabling further control over latency and security.
The terminal may take different forms, such as a handheld mobile terminal, a desktop computer, or a tablet device. The terminal may offer interactive user interface elements that allow the user to select specific subjects, matches, or time ranges to focus on, and to submit additional prompt sentences for iterative refinement. The terminal may store cached display data locally so that the user can review recommendations offline, while the server maintains a master repository of all analysis results and improvement proposals.
By implementing these embodiments, the server provides a concrete, technical mechanism that transforms raw moving image data into layered, machine-usable representations and then into adaptive, context-aware textual recommendations. This transformation pipeline improves processing speed, analytical precision, and data handling within the computing system, thereby constituting an improvement in computer technology beyond a mere automation of human mental processes.

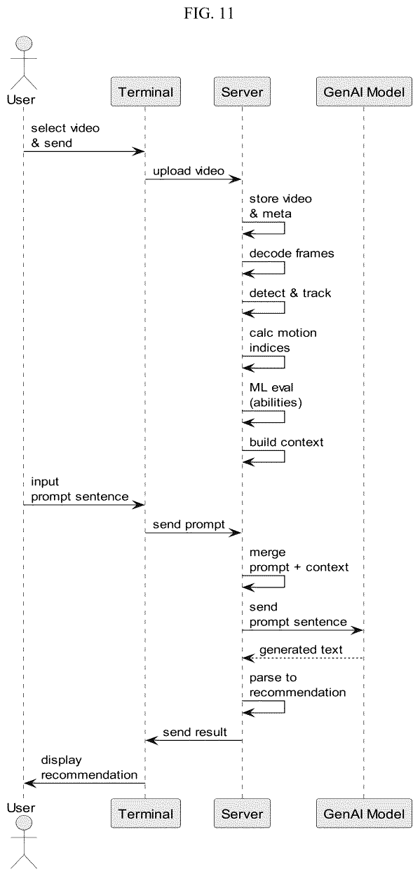

The following describes the processing flow using FIG. 11.
Step 1
User operates the terminal to select a match video file stored in local storage and to initiate an upload operation. The input is a moving image file (for example, in a compressed video format) and optional metadata such as match date or team name. The terminal packages the video file and metadata into an HTTP request using a secure protocol and sends the request to the server. The terminal performs data encapsulation (e.g., multipart/form-data), attaches headers, and transmits the byte stream over the network. The output of this step is an upload request containing the video data and metadata received by the server.
Step 2
Server receives the upload request via a network interface and parses the HTTP headers and body. The input is the network packet stream containing the video file and metadata. The server verifies the file size, type, and integrity, then writes the video data to a storage device as a file and stores the metadata in a database record linked to a match identifier. The server performs data validation, buffering in memory, and block-wise disk writes. The output of this step is a stored video file and a corresponding database entry identifying the match and file path.
Step 3
Server loads the stored video file from the storage device and decodes it into individual frames using a video processing library. The input is the file path of the video and video codec information. The server opens the file, reads encoded bitstreams, and converts them into a sequence of frame images represented as pixel matrices in memory. The server may downsample or resize frames to a standard resolution. The output of this step is a sequence of frame matrices and associated timing information such as frame indices and timestamps.
Step 4
Server performs subject detection on each frame using an object detection model implemented in a machine learning framework. The input is a frame matrix and model parameters such as weights and thresholds. The server preprocesses the frame by normalizing pixel values and resizing to the model's input resolution, then executes convolution and activation operations through the neural network layers. The server computes bounding boxes, class scores, and confidence values for detected subjects. The output of this step is a list of detected subject candidates per frame, each defined by coordinates, class label, and confidence score.
Step 5
Server tracks detected subjects across consecutive frames to generate time-series position data. The input is the per-frame detection results, including bounding boxes and frame indices. The server runs a tracking algorithm that associates detections frame-to-frame based on distance metrics and appearance features, updates internal state vectors with a state estimator, and assigns persistent track identifiers. The server calculates the center point of each bounding box as a position coordinate, indexed by track ID and frame index. The output of this step is time-series position data for each subject, stored as a sequence of coordinates with associated track IDs and timestamps.
Step 6
Server computes motion index data from the time-series position data. The input is a list of position coordinates ordered by track ID and time. The server calculates displacement between successive coordinates, multiplies by a scale factor to convert pixels to real-world units, and sums these values to obtain movement distance. The server divides displacement by frame interval to compute speed values and applies thresholding and temporal aggregation to count sprints. The server maps positions to predefined field regions and aggregates time spent in each region to derive region-wise stay distribution. The output of this step is motion index data for each subject and group-level aggregations, stored in structured records or tables.
Step 7
Server normalizes and formats the motion index data as feature vectors for a machine learning model. The input is raw motion index values such as total distance, high-intensity distance, sprint count, maximum speed, and region occupancy ratios. The server applies scaling operations, such as subtracting feature means and dividing by standard deviations, and arranges the normalized values into fixed-length vectors or tensors. The server may also compute derived features, such as distance per minute or ratio of high-intensity distance to total distance. The output of this step is a set of normalized feature tensors ready for inference by the machine learning model.
Step 8
Server performs ability evaluation using a pre-trained machine learning model. The input is the normalized feature tensors and the model parameters stored in memory. The server feeds the tensors into the neural network, executes matrix multiplications and nonlinear activations across hidden layers, and computes output scores for attributes such as endurance, speed, workload, and tactical contribution. The server may apply softmax or sigmoid functions to map raw outputs into normalized scores or categories. The output of this step is ability evaluation information for each subject, stored as structured data including scores and categorical labels.
Step 9
Server constructs analysis context information by combining motion index data and ability evaluation information. The input is the set of motion index records and ability evaluation records for each subject. The server aggregates values into a comprehensive profile, including feature summaries, evaluation scores, and temporal changes such as differences between halves or across matches. The server formats this profile as structured data (e.g., key-value pairs) and optionally as human-readable text snippets. The output of this step is analysis context information stored in a database or document store associated with each subject and match.
Step 10
Server acquires additional state information for each subject and integrates it into the analysis context information. The input is external or derived data such as biological measurements, exercise load indicators, and match-by-match performance indices. The server retrieves this data from sensor interfaces, training logs, or historical records, then aligns it in time with the current match data. The server calculates summary indicators such as fatigue level or recent workload and appends these fields to the analysis context information. The output of this step is enriched analysis context information that includes both motion-based and state-based attributes for each subject.
Step 11
Server acquires emotional state information of the user and associates it with the analysis context information. The input is user-related signals such as voice input, facial images, or operation sequences captured by the terminal and transmitted to the server. The server extracts features (e.g., acoustic features, facial expression descriptors, interaction frequency) and applies a classifier or heuristic algorithm to infer an emotional state category. The server writes the resulting emotional state information into user-related records and links it to current analysis sessions. The output of this step is emotional state information associated with the analysis context, stored for use in prompt generation and presentation adjustment.
Step 12
Server receives a prompt sentence typed by the user via the terminal and parses the instruction content. The input is a user-entered text such as “Analyze the running distance and sprint count of each player and propose a four-week stamina training plan.” The server analyzes the text to identify the requested focus (e.g., stamina improvement), target subjects (e.g., each player or a specific role), and requested output type (e.g., a four-week plan). The server may use keyword extraction or natural language parsing to structure the request. The output of this step is a parsed instruction representation that encodes the user's intent.
Step 13
Server generates instruction sentence data as a prompt sentence for input to a generative AI model by combining the analysis context information, the state information, the emotional state information, and the parsed user instruction. The input is the enriched context profile, emotional state category, and parsed instruction elements. The server inserts numerical metrics, evaluation scores, and state indicators into a textual template and appends or integrates the user's text. The server may adjust tone or detail level based on the emotional state. The output of this step is a fully constructed prompt sentence that encapsulates both machine-computed data and user intent.
Step 14
Server transmits the constructed prompt sentence to a generative AI model and receives generated text as improvement proposal information. The input is the prompt sentence and model configuration parameters such as maximum token count and sampling temperature. The server sends the prompt to the model through an application programming interface, waits for the response, and receives a text sequence containing recommendations. The generative AI model, running on local or remote computing resources, performs token-level probability computations and generates coherent output conditioned on the prompt. The output of this step is free-form natural-language text describing training plans, tactical advice, and nutrition guidance.
Step 15
Server post-processes the generated text into structured improvement proposal information. The input is the text output from the generative AI model. The server analyzes the text for structural markers such as headings and bullet-like patterns, extracts segments that correspond to training sessions, tactical instructions, or dietary recommendations, and assigns them to predefined categories. The server annotates each segment with metadata such as target subject, time period, and intensity level. The output of this step is structured improvement proposal information suitable for storage and display.
Step 16
Server converts the structured improvement proposal information into display data and transmits it to the terminal. The input is the categorized recommendations with metadata. The server formats the information as a response payload, such as a structured document or serialized objects, including sections for each subject or group. The server may compress or paginate the data to optimize transmission and rendering. The output of this step is a network response containing display-ready data delivered to the terminal.
Step 17
Terminal receives the display data from the server and renders the content for the user. The input is the response payload including training plans, tactical advice, and nutrition guidance. The terminal parses the payload, constructs visual elements such as text blocks, tables, and charts, and arranges them on the display. The terminal allows the user to navigate between subjects, expand sections, and review the generated recommendations. The output of this step is a visual presentation of the analysis and improvement proposals on the terminal display.
Step 18
User reviews the displayed information and optionally initiates additional refinement requests by entering further prompt sentences. The input is the currently displayed recommendations and the user's observations. The user may type a new text, such as “Based on the data of the central midfielder, propose drills to improve off-the-ball movement and short-distance acceleration,” or “Using the match workload and recent performance decline, suggest a weekly schedule that balances recovery and performance, including specific nutrition recommendations.” The user confirms the request via the terminal interface. The output of this step is a new instruction text sent from the terminal to the server, which restarts the cycle from the parsing and prompt construction steps for more detailed or focused guidance.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented systems for analyzing operation of industrial apparatuses typically rely on fixed rule-based algorithms, manually defined thresholds, or static templates. Such systems generally process sensor data or video data in isolation, and are not configured to flexibly integrate heterogeneous time-series data with context-dependent optimization objectives. As a result, known systems often fail to detect subtle inefficiencies or emerging anomalies in complex operation patterns, and cannot automatically generate optimized operation plans that reflect both machine state and user-specific constraints such as safety, maintainability, or quality priorities.
Furthermore, traditional analytic tools usually separate numerical computation from natural language interaction. In many cases, an operator must manually interpret numerical indicators, and then independently formulate instructions or plans for adjusting operation parameters. This separation introduces latency and human error, and prevents the computer system from providing end-to-end support, from data acquisition to actionable, machine-readable optimization output and comprehensible natural language guidance.
Additionally, existing maintenance planning systems often rely on coarse usage counters or fixed schedules, without deeply integrating operation feature data and historical load patterns at a fine-grained, time-series level. Consequently, these systems are limited in their ability to estimate degradation states and remaining useful life of components, and they cannot dynamically adjust maintenance timing based on actual operational behavior.
There is therefore a need for an improved computer technology that can (i) automatically acquire and structure operation image data and operation-related data into a unified time-series representation, (ii) prepare and supply such data as input to a generative AI model together with a prompt sentence, (iii) compute efficiency indices and anomaly determinations by comparison against reference operation patterns, (iv) generate optimized operation plans and corresponding natural language explanations computably, and (v) further refine such plans based on user-specified additional condition sentences, as well as generate maintenance proposals based on load history indices and predictive degradation estimation.

The specific processing by the specific processing unit 290 of the data processing device 12 in Application Example 1 is realized by the following means.

The present invention provides a server comprising a processor configured to acquire operation image data and operation-related data from industrial apparatuses, to analyze the operation image data by using an image processing program to generate operation feature data for each work target apparatus, to convert the operation feature data and the operation-related data into a time-series data structure and to format the time-series data structure as input data for a generative AI model, to generate a prompt sentence associated with the input data and to input the prompt sentence and the input data to the generative AI model, to cause the generative AI model to perform comparison computation between the input data and a reference operation pattern and to output an efficiency index and an abnormality determination result, to generate an optimized operation plan including at least one of an operation path, a speed, an acceleration, and a waiting time based on the efficiency index and the abnormality determination result, to generate an improvement proposal sentence expressed in natural language corresponding to the optimized operation plan, to output the efficiency index, the abnormality determination result, the optimized operation plan, and the improvement proposal sentence to an external device, to add an additional condition sentence input by a user to the prompt sentence for the generative AI model and to cause the generative AI model to regenerate the optimized operation plan including constraint conditions that prioritize at least one of safety, maintainability, and quality based on the additional condition sentence, and to calculate a load history index of a component by using the operation feature data and accumulated operation-related data, to cause the generative AI model to perform degradation state estimation and remaining life estimation based on the load history index, and to generate a maintenance proposal sentence regarding a maintenance execution timing and maintenance contents according to a result of the degradation state estimation and the remaining life estimation. This enables improvement of computer functionality by providing an integrated, computer-implemented pipeline in which heterogeneous operation data are automatically structured and supplied to a generative AI model together with context-defining prompt sentences, thereby allowing the computer system itself to compute efficiency indices, detect anomalies, generate and refine optimized operation plans under user-specified constraints, and produce predictive maintenance proposals, while reducing reliance on manual rule definition and human interpretation.

The term “operation image data” refers to digital image or video information representing operation of a physical apparatus, including sequences of frames captured by an imaging device during execution of a task by the apparatus.
The term “operation-related data” refers to non-image information associated with operation of a physical apparatus, including sensor measurements, status signals, control commands, or environmental parameters recorded over time.
The term “image processing program” refers to a software component executed by a processor that performs computational operations on image or video data, such as frame decoding, object detection, segmentation, tracking, or feature extraction.
The term “work target apparatus” refers to a physical machine or device whose operation is subject to observation, analysis, and optimization by the system, including but not limited to industrial robots, production machines, and automated tools.
The term “operation feature data” refers to numerical or symbolic values computed from operation image data and/or operation-related data that characterize behavior of a work target apparatus, including positions, velocities, accelerations, states, or other derived attributes expressed as feature vectors or time-series.
The term “time-series data structure” refers to an arrangement of data elements indexed by time, such as sequences, arrays, or tensors in which each element corresponds to one or more timestamps associated with operation feature data or operation-related data.
The term “input data for a generative AI model” refers to one or more data structures formatted for processing by a generative artificial intelligence model, including time-series tensors, feature matrices, or encoded contextual information that the model consumes to generate outputs.
The term “generative AI model” refers to a machine-learned computational model configured to produce new data or content, including numerical sequences, trajectories, or natural language text, based on learned parameter values and input data, such as neural network models.
The term “prompt sentence” refers to a text sequence, command, or description that conditions behavior of a generative AI model, specifying tasks, constraints, or objectives to be applied when processing input data.
The term “reference operation pattern” refers to an operation profile or trajectory used as a baseline for comparison with observed operation data, such as an idealized or previously learned motion pattern, performance template, or normative sequence.
The term “comparison computation” refers to processing in which numerical or symbolic differences, similarities, or relationships between input data and a reference operation pattern are calculated, including distance measures, residuals, or similarity scores.
The term “efficiency index” refers to one or more quantitative indicators computed from comparison computation that represent efficiency of operation of a work target apparatus, such as measures of path length, cycle time, energy consumption, or wasted motion.
The term “abnormality determination result” refers to information indicating presence, type, or severity of an abnormal condition in operation of a work target apparatus, derived from analysis of operation feature data or comparison with reference operation patterns.
The term “optimized operation plan” refers to a set of machine-executable or human-interpretable instructions specifying a revised operation of a work target apparatus, including parameters for operation path, speed, acceleration, timing, or other control variables intended to improve performance.
The term “operation path” refers to a spatial or state trajectory followed by a work target apparatus or its component, represented as a sequence of positions, poses, or states over time.
The term “waiting time” refers to a duration during which a work target apparatus remains in a stationary or idle state within a task sequence, including dwell times between operations or at specific positions.
The term “improvement proposal sentence” refers to natural language text generated by the system that describes recommended changes or enhancements to operation of a work target apparatus based on analysis results or an optimized operation plan.
The term “external device” refers to any computing or display apparatus separate from the server processor that receives outputs from the system, including terminals, controllers, or user interface devices.
The term “additional condition sentence” refers to a text input provided by a user that specifies supplemental requirements, preferences, or constraints to be applied by the generative AI model when generating or modifying an optimized operation plan.
The term “constraint conditions” refers to limitations or rules that restrict candidate solutions produced by the generative AI model, such as boundaries on speed, acceleration, spatial regions, or other operational parameters.
The term “safety” refers to characteristics of operation that reduce risk of harm to persons, equipment, or environment, including avoidance of hazardous regions, collisions, or excessive forces.
The term “maintainability” refers to characteristics of operation and planning that facilitate inspection, repair, or replacement of components, including scheduling and configuration that reduce maintenance burden.
The term “quality” refers to characteristics of operation that affect conformity of produced items or processes to desired specifications, including precision, consistency, and defect reduction.
The term “load history index” refers to a quantitative representation of past load conditions experienced by a component, computed from operation feature data or accumulated operation-related data, such as cumulative stress, usage count, or energy exposure metrics.
The term “degradation state estimation” refers to a process in which the generative AI model infers a current condition or health level of a component based on the load history index and other operation-related information.
The term “remaining life estimation” refers to a process in which the generative AI model predicts a remaining usable duration or number of operation cycles of a component before a specified failure or threshold condition is expected to occur.
The term “maintenance proposal sentence” refers to natural language text generated by the system that describes recommended maintenance actions, including timing and content of inspection, repair, or replacement procedures.
The term “maintenance execution timing” refers to a proposed point or interval in time or number of operation cycles at which specified maintenance actions should be performed.
The term “maintenance contents” refers to specific tasks or operations to be carried out during maintenance, such as inspection, cleaning, lubrication, adjustment, part replacement, or functional testing.

The server implements the invention by executing one or more computer programs on a hardware platform that includes at least one central processing unit, a graphics processing unit, a main memory, a nonvolatile storage device, a network interface, and interfaces to imaging devices and sensors deployed in an industrial facility. The server runs a general-purpose operating system, and the server uses a software stack including an image processing library, a numerical computation library, and a machine learning framework to perform the processing described below.
The server receives operation image data from imaging devices installed in proximity to work target apparatuses such as industrial manipulators, automated transfer systems, and machine tools. The server acquires the operation image data as digital video streams over a communication network, and the server stores the video streams as compressed video files in the storage device. The server also receives operation-related data from sensors associated with the work target apparatuses, including but not limited to position sensors, force sensors, torque sensors, vibration sensors, and controllers that output status signals and control commands. The server records the operation-related data as time-stamped numerical records in a database system.
The server uses the image processing library, such as a computer vision library running on the CPU and GPU, to decode video frames from the operation image data and to analyze each frame. The server performs object detection to identify regions corresponding to each work target apparatus, and the server performs tracking to assign persistent identifiers to detected apparatuses across multiple frames. The server further applies pose estimation or keypoint detection algorithms to infer joint locations or end-effector positions of a work target apparatus in each frame. The server converts pixel coordinates into world coordinates by applying camera calibration parameters that the server has previously computed using a camera calibration routine. Through these operations, the server generates operation feature data that consist of time-series of positions, orientations, velocities, accelerations, and discrete state indicators for each work target apparatus.
The server also correlates the operation feature data with the operation-related data by aligning timestamps on a common time base. The server implements this alignment by interpolating sensor measurements at frame timestamps or aggregating high-frequency sensor data into statistical summaries for each frame interval. The server stores the resulting combined operation feature data in a structured database in which each record is indexed by a work target apparatus identifier and a timestamp.
The server converts the operation feature data and operation-related data into a time-series data structure suitable for input to a generative AI model. The server uses a numerical computation library to assemble the data as multi-dimensional tensors, where one dimension corresponds to time and another dimension corresponds to feature components such as joint positions, velocities, forces, vibration amplitudes, and binary state flags. The server normalizes and scales each feature dimension using precomputed normalization parameters, and the server may perform data augmentation by adding Gaussian noise, time warping, or spatial jitter within safe bounds during a training phase to enhance model robustness.
The server implements the generative AI model using a machine learning framework such as a tensor-based neural network library. In one embodiment, the server configures the generative AI model as a sequence-to-sequence neural network formed by stacked recurrent units or temporal convolutional layers combined with attention mechanisms. The server may also use a variational autoencoder or a transformer-based architecture to model distributions over time-series trajectories. The server defines an encoder network that maps input time-series tensors into a latent representation and a decoder network that reconstructs or generates optimized trajectories and associated natural language tokens from the latent representation. The server trains the generative AI model using recorded datasets of operation feature data and operation-related data that are labeled with reference operation patterns and efficiency indices. During training, the server repeatedly performs forward propagation on minibatches of time-series tensors to produce predicted trajectories and predicted efficiency indices. The server computes one or more loss functions, including a reconstruction loss between predicted and reference trajectories, a regularization loss such as Kullback-Leibler divergence in a variational architecture, and auxiliary losses that penalize deviations from safety constraints or excessive jerk. The server applies backpropagation to compute gradients of the loss functions with respect to model parameters, and the server updates the parameters using an optimization algorithm such as stochastic gradient descent with momentum or an adaptive learning rate method. The server may perform hyperparameter tuning by varying layer depths, hidden dimensions, and learning rates to optimize convergence and generalization performance.
The server uses a language modeling component within the generative AI model, or connected to it, to process a prompt sentence. The server tokenizes the prompt sentence and embeds the tokens into a vector space using an embedding layer. The server fuses the embedded prompt representation with the encoded time-series representation by concatenation, cross-attention, or conditioning mechanisms so that the generative AI model can adapt its trajectory generation and explanation outputs in response to textual instructions. The server generates a prompt sentence automatically or receives the prompt sentence from the terminal. In one example, the server generates a prompt sentence such as “Analyze the motion video of the robot arm and propose an efficient motion plan that reduces cycle time while avoiding collisions.” In another example, the user inputs a prompt sentence via the terminal such as “Propose an efficient but safety-prioritized motion plan that keeps the robot at least 500 mm away from the human access zone and does not exceed current maximum speed settings.” The server incorporates these prompt sentences into the input of the generative AI model such that the model conditions its outputs on the explicit objectives and constraints specified by the prompt sentences.
The server performs comparison computation between input data and a reference operation pattern by first generating, with the generative AI model, a statistically ideal trajectory or reference pattern conditioned on the same context. The server then computes differences between the observed trajectory and the generated reference trajectory at each time step, including Euclidean distances in joint space, differences in cycle times, and differences in path lengths and maximum accelerations. The server aggregates these differences into scalar metrics that the server outputs as an efficiency index. The server determines abnormality by applying thresholds to the metrics and by computing anomaly scores from the latent representation of the generative AI model. The server may train an auxiliary classifier or use reconstruction error statistics to decide whether a given operation segment is abnormal.
The server generates an optimized operation plan by running the decoder part of the generative AI model in generation mode. The server may perform constrained decoding by adjusting logits or sampling parameters such that generated trajectories satisfy kinematic and dynamic limits preconfigured for the work target apparatus. The server post-processes the generated trajectories to ensure that the trajectories do not violate collision constraints, workspace boundaries, or speed and acceleration bounds. The server converts trajectories into a representation compatible with the controller of the work target apparatus, such as a series of waypoints and timing parameters. The server simultaneously generates an improvement proposal sentence using the natural language output of the generative AI model, for example “Shorten the vertical lift by 30 millimeters, remove idle wait at the pick position, and increase the approach speed by 15 percent while keeping torque within safe limits.” The server transmits both the optimized operation plan and the improvement proposal sentence to the terminal.
The terminal operates as a user interface device that communicates with the server. The terminal runs a web browser or a dedicated application and renders information such as efficiency indices, abnormality indications, optimized operation plans, and improvement proposal sentences on a graphical user interface. The terminal displays plots of trajectories, numerical indicators, and textual recommendations. The terminal provides input fields for the user to provide prompt sentences and additional condition sentences. The terminal sends the user's input to the server using an application programming interface over the network. The user interacts with the terminal to refine constraints on operation. The user may enter additional condition sentences such as “Limit joint acceleration to 80% of the current maximum” or “Ensure that the tool does not pass over the inspection area.” The server receives these additional condition sentences and converts them into internal constraint representations by parsing language tokens and mapping specific phrases to numerical constraint parameters. The server then adds the additional condition sentences to the prompt sentence and re-invokes the generative AI model to regenerate the optimized operation plan. The server enforces the additional constraints during trajectory generation to produce a plan that simultaneously improves efficiency and satisfies the user-specified constraints.
The server computes a load history index for each component of a work target apparatus by aggregating operation-related data and operation feature data over extended periods. The server may compute cumulative torque usage, integrated vibration energy in specific frequency bands, cumulative movement distance, or the number of high-load cycles. The server organizes these metrics into a load history index vector or scalar value for each component. The server inputs the load history index, along with recent operation feature data, into a predictive part of the generative AI model configured for health estimation. The server uses regression outputs of the model to estimate degradation state and remaining life. The server then generates a maintenance proposal sentence that specifies maintenance timing and maintenance contents, for example “Inspect the third joint gearbox within the next 500 operation cycles and replace the bearing at the next planned shutdown.” The server sends the maintenance proposal sentence to the terminal and optionally to a maintenance management system.
The server may provide a direct interface to a controller of a work target apparatus. In such an embodiment, the server converts the optimized operation plan into a controller-specific program or configuration data and transmits this data to the controller over an industrial communication protocol. The server thus causes actual motion of the apparatus to change according to the optimized operation plan. The server continues to monitor the modified operation through the imaging devices and sensors, and the server iteratively updates efficiency indices and maintenance predictions. In this way, the system is directly tied to the control and improvement of physical machinery, rather than merely providing abstract analysis.
The server improves computer technology in several ways. By structuring heterogeneous image and sensor data as unified time-series tensors and by performing fused analysis within a generative AI model, the server reduces the amount of manual feature engineering otherwise required and increases accuracy of trajectory prediction and anomaly detection. The server uses GPU-accelerated matrix operations and streaming data pipelines to reduce processing latency compared to rule-based systems that process each sensor or video source separately. The server also optimizes data storage and retrieval by organizing operation feature data and load history indices in specialized structures, enabling efficient batch queries for model inference and training.
The server uses non-conventional processing flows that are distinct from human analytical workflows. For example, the server evaluates candidate optimized trajectories in latent space before decoding them into concrete waypoints, which allows the server to impose complex constraints that human operators cannot easily visualize or enforce in real time. The server exploits latent representations learned from large datasets to infer subtle patterns of inefficiency and incipient failure that are not evident from simple thresholds.
The server improves computational accuracy by jointly optimizing multi-objective loss functions, such as combining efficiency, safety, and degradation-related penalties in the training objective. The server thereby balances competing trade-offs in a mathematically consistent manner and provides operation plans that are not trivially obtainable by human trial-and-error. The server also reduces communication load between the server and the terminal by transmitting compact summaries such as efficiency indices, optimized plans, and natural language descriptions, instead of raw video and high-frequency sensor streams. Alternative embodiments are possible within the scope of the invention. The server may implement the generative AI model as a transformer-only model for long sequences, or as a hybrid model combining convolutional encoders for image data with recurrent units for sensor data. The server may use different distance measures in the comparison computation, such as dynamic time warping or Mahalanobis distance, to better account for variations in operation timing. The server may deploy the model partially at the terminal or an edge device to reduce latency in local inference. The terminal may run a lightweight visualization and optimization interface, while the server performs heavy training operations asynchronously in the background.
In all of these embodiments, the server, terminal, and user cooperate such that the server carries out specific, technically detailed algorithms on well-defined data structures, the terminal provides an interface for issuing prompt sentences and additional condition sentences and for visualizing results, and the user supplies high-level constraints and approves or modifies the optimized operation plans. This cooperative structure ensures that the invention is concretely implemented as a computer-based improvement to the control and maintenance of physical apparatuses, with specific algorithms, models, and data flows that enhance processing speed, accuracy, and robustness beyond conventional systems.

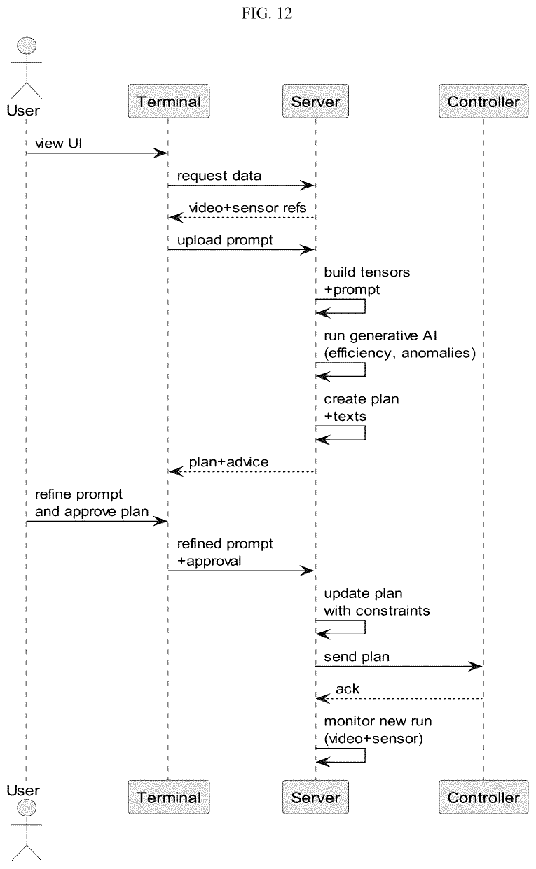

The following describes the processing flow using FIG. 12.
Step 1
The server acquires operation image data and operation-related data.
The server receives, as input, video streams from imaging devices and numerical signals from sensors associated with work target apparatuses. The server decodes the incoming video streams into individual frames and time-stamps each frame, and the server time-stamps each sensor sample based on a synchronized clock. The server writes the decoded frames into compressed video files and stores them in a storage device, and the server inserts the time-stamped sensor samples into a database as structured records. As output, the server produces stored video files and a set of time-aligned sensor records for later analysis.
Step 2
The server extracts operation feature data from the operation image data.
The server reads, as input, the stored video files from Step 1 and loads each frame into memory using an image processing library. The server performs object detection on each frame to locate each work target apparatus, and the server applies tracking across frames to assign persistent identifiers to the detected apparatuses. The server then calculates positions of joints or end-effectors in pixel coordinates, converts the pixel coordinates into world coordinates using camera calibration parameters, and computes velocities and accelerations by differentiating positions over time. The server writes, as output, operation feature data records into a structured database, where each record includes a work target apparatus identifier, a timestamp, and corresponding kinematic and state features.
Step 3
The server synchronizes operation feature data with operation-related data and constructs time-series tensors.
The server retrieves, as input, the operation feature data from Step 2 and the sensor records from Step 1 that fall within a specified time interval for a given work target apparatus. The server sorts both datasets by timestamp and interpolates sensor values to match the timestamps of the operation feature data, thereby generating synchronized feature vectors for each time step. The server concatenates kinematic features and sensor readings into unified feature vectors and groups consecutive vectors into fixed-length sequences. The server stores, as output, multi-dimensional tensors representing time-series data suitable for input to a generative AI model.
Step 4
The server generates a base prompt sentence and associates the prompt with the time-series tensors.
The server receives, as input, metadata about the task type, the work target apparatus, and the analysis objective, either from configuration data or from a request sent by the terminal. The server constructs a textual description such as “Analyze the motion video of the robot arm and propose an efficient motion plan that reduces cycle time while avoiding collisions.” by assembling template fragments and task-specific parameters. The server encodes this prompt sentence with associated identifiers for the corresponding time-series tensors, and the server stores, as output, a prompt-tensor pair that is ready to be fed to the generative AI model.
Step 5
The terminal optionally receives and forwards a user-defined prompt sentence or additional condition sentence.
The terminal displays, as input, the automatically generated prompt sentence from Step 4 and fields for user input. The user enters additional constraints or a modified prompt sentence, for example “Propose an efficient but safety-prioritized motion plan that keeps the robot at least 500 mm away from the human access zone and does not exceed current maximum speed settings.” The terminal packages the user's text together with identifiers of the relevant time-series tensors and sends, as output, a request containing the user-defined prompt sentence or additional condition sentence to the server.
Step 6
The server fuses the prompt sentence and Time-series Tensors As Input for the Generative Ai model.
The server receives, as input, the base prompt sentence and, if present, the user-defined additional condition sentence from Step 5, along with the time-series tensors from Step 3.
The server concatenates or merges the base prompt and the additional condition sentence into a single prompt sentence and tokenizes the text into a sequence of tokens. The server embeds the tokens into numerical vectors and combines these text embeddings with the time-series tensors by concatenation or attention-based conditioning. The server produces, as output, a unified input representation that includes both numerical features and encoded textual instructions for the generative AI model.
Step 7
The server performs efficiency and abnormality computation using the generative AI model. The server provides, as input, the unified input representation from Step 6 to the generative AI model hosted in memory. The server executes a forward pass through an encoder network to produce latent representations of the time-series data and the prompt sentence, and the server decodes a reference or ideal trajectory from the latent representations. The server computes differences between the observed trajectory (derived from the tensors) and the reference trajectory, including path length ratios, cycle time differences, and maximum acceleration deviations. The server aggregates these differences into scalar and vector metrics, and the server applies anomaly detection criteria to determine whether segments are abnormal. The server stores, as output, an efficiency index and an abnormality determination result associated with the analyzed time interval and work target apparatus.
Step 8
The server generates an optimized operation plan by constrained decoding.
The server receives, as input, the latent representations, the efficiency index, and the abnormality determination result from Step 7, together with configuration data specifying allowable ranges for path, speed, acceleration, and waiting time. The server runs the decoder part of the generative AI model to generate candidate trajectories and applies constraint-enforcing logic that clips or adjusts candidate outputs to remain within pre-defined safety and kinematic limits. The server evaluates multiple candidate trajectories in latent or feature space using cost functions that combine efficiency improvement and constraint satisfaction, and the server selects the trajectory that minimizes the cost. The server converts the selected trajectory into an optimized operation plan consisting of discrete waypoints, timing parameters, and motion commands. As output, the server obtains a controller-oriented optimized operation plan.
Step 9
The server generates an improvement proposal sentence and a maintenance proposal sentence.
The server takes, as input, the optimized operation plan from Step 8, the efficiency index and abnormality determination result from Step 7, and historical operation feature data and sensor-derived load history information. The server uses a language generation component conditioned on the latent representations and optimization results to construct an improvement proposal sentence in natural language that explains recommended changes, for example “Shorten the vertical lift by 30 millimeters and remove idle wait at the pick position.” The server also computes a load history index for components and feeds this index, together with recent operational patterns, into a predictive part of the generative AI model to estimate degradation state and remaining life. Based on these estimates, the server constructs a maintenance proposal sentence specifying timing and contents of maintenance. As output, the server produces human-readable improvement and maintenance proposal sentences associated with the optimized operation plan.
Step 10
The terminal presents analysis results and plans to the user.
The terminal receives, as input, the efficiency index, abnormality determination result, optimized operation plan, improvement proposal sentence, and maintenance proposal sentence from the server. The terminal parses the data and renders visualizations such as trajectory plots, efficiency graphs, and status indicators, and the terminal displays the improvement and maintenance proposal sentences as text. The terminal formats the optimized operation plan into a human-readable table or diagram showing waypoints and timings. As output, the terminal provides an interactive interface that allows the user to inspect results and select or modify plans.
Step 11
The user reviews, modifies, and confirms the optimized operation plan.
The user observes, as input, the displayed metrics, trajectories, and proposal sentences on the terminal. The user may adjust parameters such as desired safety margin, maximum allowable speed, or preferred maintenance window using controls on the terminal. The user optionally enters a refined prompt sentence to impose new constraints or preferences and requests a re-computation. After reviewing the revised optimized operation plan, the user confirms a selected plan for deployment. As output, the user's confirmation and any refined prompt sentences are transmitted from the terminal to the server.
Step 12
The server exports and optionally deploys the optimized operation plan to a controller.
The server receives, as input, the user's selection and confirmation from Step 11, together with the finalized optimized operation plan from Step 8. The server converts the plan into a format compatible with the controller of the work target apparatus, such as a sequence of controller-specific motion instructions. The server either sends the formatted plan directly to the controller over an industrial communication interface or provides the plan to the terminal for manual transfer. The server records, as output, that the new plan has been exported or deployed and updates its internal database so that subsequent monitoring and analysis refer to the updated operation configuration.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional performance analysis systems for sports rely primarily on manual tagging of events in video, simple aggregate statistics, or rigid rule-based processing pipelines. Such systems suffer from several technical drawbacks when implemented on general-purpose computer hardware. First, automatic extraction of fine-grained movement data from video streams typically requires separate, loosely-coupled modules for decoding, detection, tracking, metric computation, and report generation. These modules frequently operate on heterogeneous data formats and lack a unified representation that can be directly consumed by higher-level analytic components. As a result, substantial intermediate data transformation and manual configuration are required, which increases processing latency, memory footprint, and error rates in large-scale deployments.
Second, in existing systems, the generation of personalized training recommendations and nutritional guidance is either manual or hard-coded. Even when machine-learning models are used, their outputs are usually fixed-format numerical scores that are not easily reusable for subsequent natural language generation. This causes a technical gap between the low-level numerical processing performed by the server and the generation of high-quality, context-aware textual feedback. In order to bridge this gap, conventional architectures often add additional application logic layers or external scripting, which introduce duplicated computations and inefficient data flows.
Third, conventional server-side implementations do not treat prompt generation for generative AI models as a first-class computational object. Prompt sentences, if used at all, are typically crafted manually or via ad hoc templates with limited access to the full set of motion indices, model outputs, and contextual state. The absence of an integrated prompt-generation mechanism leads to suboptimal utilization of generative AI capabilities, because the prompts lack consistent structure, omit relevant quantitative data, or fail to encode user state such as physical condition or emotional state. This results in unstable response quality, difficulty in debugging and improving the system, and poor scalability across many users and events.
Fourth, existing systems are generally not configured to combine heterogeneous state information—such as video-derived motion indices, machine-learning-based ability evaluations, physical condition data, lifestyle data, and emotion estimations—into a machine-consumable representation that can be robustly transformed into natural language prompts. As a consequence, the server cannot efficiently orchestrate a pipeline in which raw multimedia data and multi-modal user context are converted into a normalized, structured state and then into optimized prompt sentences for a generative AI model, all within one coherent computational framework.
Accordingly, there is a need for an improved computer-implemented system and server-side architecture that (i) automatically converts video information into structured movement-trajectory and motion-index information, (ii) integrates this information with additional state data such as condition information and emotion information, and (iii) programmatically generates and manages prompt sentences for a generative AI model based on these unified internal representations. Such a system should reduce the number of transformation layers, minimize redundant processing, and provide a technically efficient way to produce high-quality, individualized training and nutritional proposals, thereby improving the overall performance, scalability, and robustness of the computer system itself.

The specific processing by the specific processing unit 290 of the data processing device 12 in Example 2 is realized by the following means.

The present invention provides a server comprising a processor and a memory storing instructions that, when executed by the processor, cause the processor to control a communication terminal to transfer motion-sport-related video information to the server; to decode the video information into time-series still-image information and execute object-detection processing and tracking processing using image-processing software or machine-learning software to extract position information of sport participants and sport equipment on a per-frame basis and transform the position information into a coordinate system of a playing field to generate movement-trajectory information for each sport participant; to compute, for each sport participant, motion-index information including running distance, speed, frequency of acceleration actions, and success rate of technical actions on the basis of the movement-trajectory information and the position information of the sport equipment, and to input the motion-index information as feature data into a statistical-learning model or a machine-learning model to obtain ability-evaluation information; to convert the motion-index information and the ability-evaluation information into explanatory text in natural language; to automatically generate a first prompt sentence including the explanatory text, the first prompt sentence instructing a generative AI model to create a performance summary and improvement content for each sport participant, and to input the first prompt sentence into the generative AI model to obtain improvement-proposal information including training content and tactical advice, the processor further being configured to acquire, from the communication terminal, condition information including at least one of physical-state information and lifestyle information, integrate the condition information with the motion-index information and the ability-evaluation information to generate individual-state information, and automatically generate a second prompt sentence including the individual-state information, the second prompt sentence instructing the generative AI model to propose a training plan and nutritional intake content for each sport participant, and to input the second prompt sentence into the generative AI model to obtain training-plan information and nutrition-advice information, and, in some embodiments, to use emotion-estimation software to perform emotion-estimation processing based on user voice information, image information, or operation information to acquire emotion information, associate the emotion information with the motion-index information and the ability-evaluation information to generate emotion-added state information, and automatically generate a third prompt sentence including the emotion-added state information, the third prompt sentence instructing the generative AI model to create performance evaluation and improvement proposals that take the emotion into account, and to input the third prompt sentence into the generative AI model to obtain advice information responsive to the emotion, and to associate and store the improvement-proposal information, the training-plan information, the nutrition-advice information, and the advice information responsive to the emotion together with the motion-index information and the ability-evaluation information as output data. This enables a unified, computer-implemented pipeline in which raw video information and multi-modal user state are automatically converted into structured internal representations and dynamically constructed prompt sentences for a generative AI model, thereby reducing redundant data transformations, improving the efficiency and scalability of server-side processing, and enhancing the quality and consistency of individualized training and nutritional proposals generated by the overall computer system.

The term “processor” refers to a hardware processing unit or combination of hardware processing units, such as a central processing unit or a graphics processing unit, that executes instructions to perform arithmetic, logical, control, and input/output operations.
The term “memory” refers to a hardware storage device or combination of hardware storage devices, such as volatile memory or non-volatile memory, that stores instructions and data for access by a processor.
The term “server” refers to an information processing apparatus including at least one processor and at least one memory, configured to receive data from one or more communication terminals, execute computational processing on the data, and transmit results to the communication terminals or other devices.
The term “communication terminal” refers to an electronic device operated by a user, such as a portable terminal or a general-purpose computing device, configured to capture, store, display, and transmit information to and from the server via a communication network.
The term “video information” refers to time-series image data representing a physical scene, including, for example, a series of frames encoded in a digital video format that depicts motion of objects over time.
The term “motion-sport-related video information” refers to video information capturing a sports activity in which one or more participants physically move in a playing area, such as a field or court, during a competitive or training event.
The term “time-series still-image information” refers to a plurality of image frames obtained from video information, each frame representing a still image at a specific time point, and ordered according to their temporal sequence.
The term “image-processing software” refers to program code or a software library executed by a processor to perform operations on image data, including decoding, resizing, color conversion, filtering, segmentation, object detection, or tracking.
The term “machine-learning software” refers to program code or a software framework executed by a processor to perform learning or inference based on data using statistical models or neural networks, including models for classification, regression, detection, or sequence prediction.
The term “object-detection processing” refers to computational processing that receives image data and outputs, for each image, a set of regions corresponding to detected objects, each region being associated with a class label and, optionally, a confidence score.
The term “tracking processing” refers to computational processing that associates detected objects across a plurality of frames in time-series still-image information, assigns identifiers to the objects, and maintains trajectories of the objects over time.
The term “sport participant” refers to a physical entity, such as a player, athlete, or official, that participates in a sports activity and whose movement is detectable within the video information.
The term “sport equipment” refers to a physical object used in a sports activity, such as a ball, goal, net, or other apparatus, whose position and movement may be detected and analyzed within the video information.
The term “position information” refers to data that indicates a location of an object in a given reference frame, such as coordinates of a region in an image or coordinates in a real-world coordinate system.
The term “playing field” refers to a physical area or surface, such as a field, court, or pitch, in which a sports activity takes place and on which sport participants and sport equipment move.
The term “coordinate system of a playing field” refers to a reference system, such as a two-dimensional or three-dimensional coordinate system, defined on the playing field and used to represent positions of sport participants and sport equipment in real-world units.
The term “movement-trajectory information” refers to data representing a temporal sequence of positions of an object, such as a sport participant or sport equipment, over time in the coordinate system of the playing field.
The term “motion-index information” refers to quantitative indicators derived from movement-trajectory information and related data, including measures such as distance traveled, speed, frequency of specific motion patterns, and success rates of actions.
The term “running distance” refers to a component of motion-index information that represents a total path length traveled by a sport participant over a given time interval, computed from movement-trajectory information.
The term “speed” refers to a component of motion-index information that represents a rate of change of position of a sport participant over time, typically expressed as distance per unit time.
The term “frequency of acceleration actions” refers to a component of motion-index information that represents the number of movement segments in which a sport participant's speed increases beyond a predefined threshold within a given time interval.
The term “success rate of technical actions” refers to a component of motion-index information that represents a ratio between successful occurrences of a defined technical action and total occurrences of the action, expressed as a percentage or similar measure.
The term “statistical-learning model” refers to a data-driven model configured by fitting parameters to training data using a statistical learning algorithm, such as linear regression, logistic regression, decision trees, or ensemble models, to predict outputs from input features.
The term “machine-learning model” refers to a computational model, including but not limited to neural networks, probabilistic models, or other learning architectures, that is trained on data to map input features to output values or categories.
The term “feature data” refers to a set of numerical or categorical values derived from raw data and used as input to a statistical-learning model or a machine-learning model for inference or prediction.
The term “ability-evaluation information” refers to data output from a statistical-learning model or a machine-learning model that represents an evaluation of capabilities or performance characteristics of a sport participant, such as stamina, speed, technical skill, or tactical understanding.
The term “natural language” refers to a human language, such as English, that is used for communication between humans and can be processed and generated by language-processing systems.
The term “explanatory text in natural language” refers to textual information composed in natural language and describing or interpreting quantitative or qualitative data in a human-readable form.
The term “generative AI model” refers to a machine-learning model configured to generate data, such as text, based on a given input, where the model is trained to produce coherent, context-aware outputs in response to instructions or prompts.
The term “prompt sentence” refers to one or more sentences or textual segments in natural language that provide instructions, context, or constraints to a generative AI model, guiding the model to generate a desired type of output.
The term “performance summary” refers to natural-language text generated or configured to summarize motion-index information and ability-evaluation information of a sport participant in a concise, human-readable form.
The term “improvement content” refers to natural-language text generated or configured to provide guidance on how a sport participant can enhance performance, including suggested exercises, strategies, or focus areas.
The term “improvement-proposal information” refers to data generated by a generative AI model in response to a prompt sentence, including performance summaries, training suggestions, tactical advice, and other recommendations for improving performance.
The term “training content” refers to specific instructions, plans, or drills that are configured to be performed by a sport participant to improve physical or technical performance.
The term “tactical advice” refers to natural-language guidance related to decisions, positioning, or strategies used in a sports activity, configured to improve tactical understanding and in-game behavior.
The term “output data” refers to data produced by the server for delivery to a communication terminal or other device, including motion-index information, ability-evaluation information, improvement-proposal information, training-plan information, nutrition-advice information, and emotion-responsive advice information.
The term “condition information” refers to data relating to a user's physical state or lifestyle, including, for example, fatigue level, sleep quantity, illness status, training frequency, or other factors that influence performance and recovery.
The term “physical-state information” refers to data describing a user's current or recent physical condition, such as fatigue, injury status, pain level, or physiological parameters.
The term “lifestyle information” refers to data describing habitual or contextual aspects of a user's life, such as sleep duration, diet patterns, training schedule, and daily activity levels.
The term “individual-state information” refers to a unified representation of a sport participant's status obtained by integrating condition information with motion-index information and ability-evaluation information.
The term “training plan” refers to a structured schedule or set of sessions specifying frequency, duration, and type of training activities designed to improve specific aspects of performance.
The term “nutritional intake content” refers to information regarding recommended types, quantities, timing, or combinations of foods and fluids to be consumed by a user to support health, performance, and recovery.
The term “training-plan information” refers to data generated by a generative AI model describing a training plan tailored to a sport participant's individual-state information.
The term “nutrition-advice information” refers to data generated by a generative AI model describing recommended nutritional intake content tailored to a sport participant's individual-state information.
The term “emotion-estimation software” refers to program code executed by a processor to analyze user-related data, such as voice, image, or operation patterns, and to infer an emotional state or category.
The term “emotion information” refers to data representing an estimated emotional state of a user, such as stress, motivation, frustration, or satisfaction, expressed as labels, scores, or probabilities.
The term “emotion-added state information” refers to state information generated by associating emotion information with motion-index information and ability-evaluation information, thereby representing both performance and emotion-related context.
The term “emotion-responsive advice information” refers to data generated by a generative AI model that provides performance evaluation or improvement proposals adapted to or taking into account the associated emotion information.
The term “user voice information” refers to audio data capturing spoken utterances or vocalizations made by a user, used as input to emotion-estimation software.
The term “image information” refers to still-image data or time-series image data capturing the appearance or expression of a user, used as input to emotion-estimation software.
The term “operation information” refers to data derived from user interactions with a communication terminal or user interface, such as input patterns, touch behavior, or selection history, used as input to emotion-estimation software.

In one embodiment, a server, a communication terminal, and a communication network cooperate to implement the claimed system. The server comprises at least one processor and at least one memory storing instructions. The processor executes the instructions to perform decoding of motion-sport-related video information, detection and tracking of objects, computation of motion-index information, generation of feature data, inference by statistical-learning and machine-learning models, construction of prompt sentences for a generative AI model, and integration of outputs of the generative AI model into structured output data. The terminal comprises at least one processor, at least one memory, a camera, a display, and a communication interface, and is configured to capture sports video, present user interfaces, and transmit and receive data to and from the server.

The server uses general-purpose computer hardware such as a multi-core central processing unit and, in some embodiments, a graphics processing unit for accelerated matrix computation. The server executes an operating system such as a general-purpose server operating system, a web server program, and application programs implemented using a server-side framework. The server also executes image-processing software, such as a library that provides video decoding and image manipulation functions, and machine-learning software, such as a framework that provides tensor operations, neural-network operations, and model-serving functionality.
The terminal uses a camera application or a dedicated application to capture motion-sport-related video information during a sports activity and stores the captured video in a local storage unit as a compressed video file. The terminal executes an application configured to allow a user to select a stored video file, attach descriptive metadata such as sport type, age category, and match date, and transmit the video file and the metadata to the server via a secure communication protocol. The terminal displays progress indicators during upload and receives a match identifier or similar reference information from the server after successful upload.
The server receives a sequence of binary data chunks representing the compressed video file and writes the chunks to a file system or an object storage service. The server registers an entry in a data store associating the stored video file with the received metadata and a user identifier. The server then uses image-processing software to decode the compressed video data into time-series still-image information, namely a sequence of frames represented as multidimensional arrays of pixel values. In one embodiment, the server uses a video decoding interface that reads frames sequentially, and for each frame, the server converts the color format into a standardized format and resizes the frame to a predetermined resolution to reduce memory usage and standardize input to subsequent machine-learning models.
The server applies object-detection processing to the frames using machine-learning software. In one embodiment, the server loads a convolutional neural network model for object detection that follows a one-stage detection architecture. The detector receives as input a tensor representing an image frame and outputs, for each of a plurality of anchor regions, a class probability vector and bounding-box regression parameters. The server executes a non-maximum suppression algorithm to remove redundant overlapping detections, and keeps detections for one or more classes corresponding to sport participants and sport equipment.
The server outputs, for each frame, a list of detection records, each record including bounding-box coordinates, a class label, and a confidence score.
The server performs tracking processing by associating detections corresponding to sport participants across successive frames. In one embodiment, the server implements a multi-object tracking algorithm that combines a Kalman filter for motion prediction with a matching algorithm based on distance in image coordinates and, in some implementations, feature embeddings extracted from cropped regions of the frame using a smaller neural network. The server maintains, for each tracked participant, a track identifier and a time-ordered list of bounding-box centers. The server handles occlusions and temporary detection loss by predicting positions using the Kalman filter state and performs track termination and initiation based on configurable time thresholds and confidence scores. The server transforms the position information in the image coordinate system into a coordinate system of a playing field. In one embodiment, the server stores a homography matrix for the camera view corresponding to the uploaded video, which is precomputed based on known correspondences between points on the playing field and their image coordinates. The server multiplies the bounding-box center coordinates by the homography matrix to obtain two-dimensional field coordinates in a unit corresponding to real-world distance, such as meters. The server produces movement-trajectory information for each sport participant by storing pairs of timestamps and field coordinates in a data structure indexed by the track identifier.
The server computes motion-index information based on the movement-trajectory information and the position information of sport equipment. The server iterates through the movement-trajectory information of each sport participant, computes the Euclidean distance between successive positions, accumulates the distances over a specified time range, and obtains a running distance measure. The server divides the distance between successive positions by the time difference to compute speed values, and identifies acceleration actions when the difference of successive speed values exceeds a threshold. The server counts the number of acceleration actions and may compute related statistics such as average and maximum speed.
The server estimates technical actions and their success rates by analyzing the relative positions of sport participants and sport equipment. For example, the server determines that a pass event has occurred when the detected sport equipment transitions from the vicinity of a first participant to the vicinity of a second participant according to distance and time thresholds, and regards the pass as successful when the sport equipment remains in the vicinity of the receiving participant within a given time window. The server counts the number of passes attempted and successful passes and computes a success rate as a percentage. The server stores the motion-index information for each participant in a data store as structured data.
The server generates feature data for use by a statistical-learning model or a machine-learning model for ability evaluation. The server constructs, for each sport participant, a feature vector that includes numerical values representing motion indices such as running distance, number of acceleration actions, pass success rate, distances in different time segments, and ratios of performance metrics across the duration of the sports activity. The server may normalize feature values using predetermined means and variances or perform other scaling to ensure compatibility with the trained models. The server inputs the feature vectors into a model inference module implemented using the machine-learning software.
In one embodiment, the server uses a feedforward neural network for ability evaluation. The network comprises an input layer whose dimension matches the number of features, one or more hidden layers with non-linear activation functions such as rectified linear units, and an output layer providing values representing ability-evaluation information, such as stamina scores, speed scores, and technical skill scores. The server performs a forward pass through the network by matrix multiplications and activation operations implemented by the machine-learning software and obtains the output values. During model training, which may be performed offline, the server or another training system uses recorded match data and expert-labeled ability scores to compute a loss function such as a mean squared error or a cross-entropy loss, and applies an optimization algorithm such as stochastic gradient descent with momentum or an adaptive learning-rate method to update network weights. The trained model parameters are then deployed to the server for inference.
The server converts the motion-index information and the ability-evaluation information into explanatory text in natural language. The server generates textual fragments, each describing a single metric or evaluation, such as “Total distance: 5.0 kilometers,” “Number of high-intensity sprints: 15,” “Pass success rate: 80 percent,” or “Estimated stamina level: moderate, with noticeable decline in the last 15 minutes.” The server concatenates these fragments in a predetermined order and adds connective text and role instructions for a generative AI model, thereby constructing a prompt sentence.
The server formulates a prompt sentence that instructs a generative AI model to produce performance summaries and improvement content. In one example, the server generates the following prompt sentence:
“You are a professional soccer coach and conditioning specialist.
Analyze the following junior player's match performance data and create practical improvement advice.
Player: A, Age: 11, Position: Midfielder.
Metrics: Total distance 5.0 km, Sprints 15, Pass success rate 80%.
Additional analysis: Stamina score 45/100, clear distance and sprint decrease in the last 15 minutes.
Provide:
1) A short performance summary in plain language,
2) Three specific training recommendations tailored to an 11-year-old player, focusing on improving stamina and maintaining intensity in the second half,
3) One or two simple drills that can be executed in 20-30 minutes per training session.”
The server transmits the prompt sentence to a generative AI model. In one embodiment, the server accesses a large language model deployed on a model-serving platform. The generative AI model, for example a transformer-based neural network, receives tokenized representations of the prompt sentence and computes attention-weighted representations across multiple layers to generate output tokens. The server receives a sequence of output tokens representing natural-language text, decodes the tokens into characters, and obtains improvement-proposal information including performance summaries, training content, and tactical advice.
The server uses a similar mechanism to generate condition-aware prompt sentences. The terminal presents user interfaces that allow a user to input condition information such as sleep duration, subjective fatigue level, recent illness, or weekly training schedule. The terminal transmits this condition information to the server along with identifiers of relevant sports activities and participants. The server integrates the condition information with motion-index information and ability-evaluation information to form individual-state information. The server then generates a prompt sentence that describes the individual-state information and instructs the generative AI model to provide a training plan and nutritional intake content. For example, the server may generate a prompt sentence such as:
“You are a sports nutritionist specializing in junior soccer players.
Player: A, Age: 11, Weight: 35 kg.
Weekly schedule: 2 training sessions and 1 match.
Match performance: total distance 5.0 km, stamina decline in the last 15 minutes.
The player reports moderate fatigue and sleeps about 7 hours per night.
Goal: improve stamina and recovery while ensuring safety and suitability for a child.
Provide:
1) General daily nutrition guidelines,
2) Specific pre-match meal advice,
3) Specific post-match recovery snack ideas.
Use simple language that parents can easily understand.”
The server provides this prompt sentence to the generative AI model and receives training-plan information and nutrition-advice information. The server stores these outputs in association with the corresponding movement-trajectory information, motion-index information, and ability-evaluation information. The server then prepares output data for delivery to the terminal, which may include textual recommendations and, in some embodiments, graphical summaries based on the underlying numerical data.
In some embodiments, the server further uses emotion-estimation software to incorporate emotion information into the processing pipeline. The terminal captures user voice information, image information, or operation information, such as the speed and pattern of user interactions with the application. The terminal transmits such information, or derived features, to the server. The server executes an emotion-estimation model implemented by a neural network, such as a recurrent or convolutional architecture for audio, or a convolutional or transformer-based architecture for images, and outputs emotion labels or scores. The server associates the emotion information with motion-index information and ability-evaluation information to generate emotion-added state information. The server constructs a prompt sentence that includes the emotion-added state information and instructs the generative AI model to generate advice that takes into account the user's emotional state. The generative AI model then produces emotion-responsive advice information, which the server stores and transmits to the terminal.
The server implements these pipelines using specific data structures and process flows that improve computational efficiency. The server stores movement-trajectory information in a time-indexed table, allowing efficient aggregation by time interval and participant. The server caches intermediate representations such as decoded frames and detection results in memory or high-speed storage to avoid redundant processing when re-analysis or additional models are applied. The server generates prompt sentences by composing reusable text templates with variable placeholders, which reduces string manipulation overhead and ensures consistent structure for the generative AI model, thereby stabilizing inference time and output quality.
The described combination of video decoding, object detection and tracking, coordinate transformation, motion-index computation, model-based ability evaluation, and prompt-sentence generation yields technical effects beyond manual analysis or simple automation. The server reduces the amount of video data that must be repeatedly processed by transforming it into compact numerical trajectories and indices that are reusable across multiple analysis tasks. This reduction in data volume and standardization of internal representation decreases memory usage and accelerates downstream computations. The server increases the precision of performance analysis by using machine-learning models trained on large datasets, which identify complex relationships between motion indices and latent abilities that are not captured by simple threshold rules.
The server improves the functioning of the computer system by integrating prompt-sentence generation directly into the data-processing pipeline. Because the server constructs prompt sentences from structured representations that include motion indices, evaluation scores, condition information, and emotion information, the generative AI model receives richer and more precisely structured context than would be feasible with manual or ad hoc prompting. This leads to more stable and relevant outputs, reducing the need for multiple back-and-forth queries and decreasing overall processing time and network usage. Additionally, the server's use of homography-based coordinate transformation and multi-object tracking yields consistent and field-referenced coordinates that simplify subsequent computation and storage compared to operating solely in image coordinates.
The server's use of neural-network architectures and training methods is also directed to technical improvements. By selecting appropriate network depth and width, activation functions, and regularization methods, and by using loss functions tailored to multi-dimensional output, the server obtains models that generalize accurately across different sports activities and camera configurations. The server may perform data augmentation on training data, such as random cropping, scaling, or brightness adjustments for image frames, to increase robustness of object detection and tracking in varied lighting and environmental conditions. These techniques improve model accuracy and reduce error rates in automatic detection and evaluation tasks.
The server and terminal cooperate to present results in a technically efficient manner. The server transmits only compact motion-index information, ability-evaluation information, and natural-language outputs to the terminal, avoiding the need to transmit large volumes of raw video back to the user when not necessary. This reduces communication bandwidth requirements and improves responsiveness for users accessing the system via limited network connections. The terminal can reconstruct useful visualizations, such as heat maps or time-series graphs, using the compact data, which further demonstrates that the system operates with improved data management and transmission efficiency.
In alternative embodiments, the server may adjust the architecture of the neural networks, the set of motion indices computed, or the structure of the prompt sentences, while maintaining the core principles of converting video into structured trajectories, computing indices, evaluating abilities, and generating context-rich prompt sentences for a generative AI model. For example, the server may adopt a transformer-based object detector instead of a convolutional detector, use a recurrent neural network to model time dependencies in motion-index sequences, or employ different textual templates for different sports or age groups. These variations still achieve the same technical objective of improving the efficiency, scalability, and quality of computer-implemented sports performance analysis and recommendation generation.

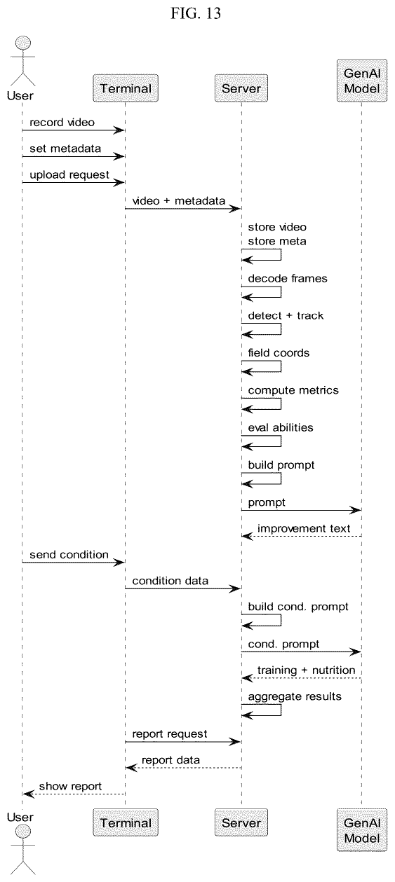

The following describes the processing flow using FIG. 13.
Step 1
The user captures sports video and prepares metadata.
The user operates the terminal to record a sports event using an integrated camera application, and the terminal stores the captured content as a compressed video file together with time information in local storage. The user then operates an application or web browser on the terminal to open an upload screen and selects the recorded video file and inputs metadata such as sport type, age category, team name, and match date.
Input: Raw sensor data from the camera and user-entered metadata.
Output: A compressed video file stored on the terminal and a set of associated metadata values.
Step 2
The terminal transmits the video file and metadata to the server.
The terminal reads the selected compressed video file in binary chunks from local storage and constructs an HTTPS POST request containing the binary chunks as a multipart body, together with serialized metadata fields. The terminal then sends the request over a communication network to an upload endpoint of the server and waits for a response.
Input: The compressed video file and metadata stored on the terminal.
Output: A network request containing video data and metadata transmitted to the server.
Step 3
The server receives and stores the video and metadata.
The server accepts the HTTPS request via a web server component and passes the request body to an application program. The server sequentially writes the received binary chunks into a file in a file system or an object in a storage service, and parses the metadata fields from the request. The server generates a unique match identifier and stores a record in a database associating the file path or storage key with the metadata and user identifier.
Input: The uploaded request containing video binary data and metadata.
Output: A persisted video file in server-side storage and a database record including a match identifier and metadata.
Step 4
The server decodes the video into time-series frames.
The server invokes image-processing software to open the stored compressed video file and reads it frame by frame. For each frame, the server decodes encoded video data into a multidimensional array of pixel values, converts the color format into a standard format, and resizes the frame to a predefined resolution. The server assigns a frame index and a timestamp to each frame and stores references to the frames in memory or temporary storage.
Input: The compressed video file stored on the server.
Output: A sequence of standardized image frames with associated frame indices and timestamps.
Step 5
The server performs object detection for sport participants and equipment.
The server loads an object-detection model implemented with machine-learning software and, for each frame or batch of frames, constructs input tensors from the pixel arrays. The server executes the model to obtain candidate bounding boxes, class probabilities, and confidence scores. The server applies non-maximum suppression to eliminate redundant overlapping boxes and discards detections whose confidence is below a threshold. The server retains detections labeled as sport participants or sport equipment and stores, for each frame, the resulting list of detection records.
Input: Standardized image frames with indices and timestamps.
Output: Detection data per frame including bounding boxes, class labels, and confidence scores.
Step 6
The server tracks sport participants across frames.
The server initializes a tracking module that maintains track states. For each new frame, the server retrieves the corresponding detections and predicts current positions of existing tracks using a motion model such as a Kalman filter. The server computes distances or similarity scores between predicted track positions and new detections, and assigns detections to existing tracks using an assignment algorithm. The server updates track states with the associated detections, creates new tracks for unmatched detections, and terminates tracks that remain unmatched for a defined duration. The server records a time-ordered list of bounding-box centers and timestamps for each track identifier.
Input: The per-frame detection data for sport participants.
Output: Tracking data comprising track identifiers and associated sequences of bounding-box centers over time.
Step 7
The server converts image coordinates into playing-field coordinates.
The server retrieves or computes a homography matrix or other mapping function representing the geometric relationship between the image plane and the playing field. For each bounding-box center in the tracking data, the server multiplies the image coordinates by the mapping function to obtain real-world coordinates on the playing field. The server generates movement-trajectory information by pairing each timestamp with its corresponding field coordinate for each track identifier, and stores this information in a structured data table.
Input: Tracking data with image-based bounding-box center coordinates and timestamps.
Output: Movement-trajectory information with playing-field coordinates and timestamps per track identifier.
Step 8
The server computes motion-index information for each participant.
The server groups movement-trajectory information by track identifier and sorts each group by timestamp. The server calculates the Euclidean distance between consecutive field coordinates and accumulates the distances to compute total running distance. The server divides each distance by the corresponding time interval to compute speed values and identifies acceleration actions where speed increases by more than a predetermined threshold. The server also segments the time axis into intervals, such as halves or fixed minute windows, and recomputes distances and speeds in each segment. The server calculates motion indices including total distance, number of acceleration actions, segment-based distances, and average and maximum speeds, and stores these indices per participant.
Input: Movement-trajectory information grouped by track identifier.
Output: Motion-index information per participant, including distance, speed, and acceleration-related metrics.
Step 9
The server infers technical action success rates.
The server analyzes the movement-trajectory information of sport equipment in combination with the trajectories of participants. For each detected change in equipment possession inferred from proximity and velocity, the server identifies a technical action such as a pass. The server determines whether the equipment remains near the receiving participant for a specified time interval, and, if so, marks the action as successful. The server counts the total number of such actions and the number of successes per participant and computes success rates as ratios. The server combines these technical metrics with motion indices to form an extended set of motion-index information.
Input: Movement-trajectory information for participants and sport equipment.
Output: Extended motion-index information including counts and success rates of technical actions.
Step 10
The server generates feature vectors for ability evaluation.
The server assembles, for each participant, a feature vector containing numerical elements representing motion indices and technical metrics, such as total distance, high-intensity distance, number of acceleration actions, technical action counts, success rates, and performance ratios between different time segments. The server applies normalization or scaling to the features if necessary to match the expected input range of an evaluation model. The server stores the feature vectors in a format suitable for batch inference.
Input: The extended motion-index information per participant.
Output: Normalized feature vectors per participant for input to an ability-evaluation model.
Step 11
The server evaluates participant abilities using a machine-learning model.
The server loads an ability-evaluation model, such as a feedforward neural network, with pre-trained parameters from storage into memory. The server constructs input tensors from the feature vectors and performs forward propagation through the layers of the model, executing matrix multiplications and activation functions. The server obtains output values corresponding to ability-evaluation information, such as stamina scores, speed scores, and technical skill scores, and optionally discrete labels or tags. The server associates these outputs with the respective participants and stores them in the database.
Input: The normalized feature vectors for each participant.
Output: Ability-evaluation information for each participant, including numerical scores and, optionally, categorized evaluation tags.
Step 12
The server converts indices and evaluations into explanatory text.
The server retrieves motion-index information and ability-evaluation information from the database for a specific participant and constructs textual fragments for each important metric and evaluation. The server formats numeric values into human-readable units and embeds them into phrase templates such as “Total distance: X kilometers” or “Stamina score: Y out of 100, with noticeable decline in the last Z minutes.” The server concatenates the fragments with connective text and role descriptions, thereby producing a structured, natural-language explanation of the participant's performance.
Input: Motion-index information and ability-evaluation information for each participant.
Output: Explanatory text in natural language describing performance metrics and evaluations.
Step 13
The server constructs prompt sentences for the generative AI model.
The server defines one or more text templates that specify instructions for the generative AI model and placeholders for explanatory text, participant attributes, and analysis targets. The server combines the natural-language explanation with contextual details such as age, position, and goals and inserts them into the template. For example, the server creates a prompt sentence that includes instructions like “Analyze the following junior player's match performance data and create practical improvement advice,” lists the key metrics, and specifies the format of the desired output. The server stores the resulting prompt sentences for subsequent use.
Input: Explanatory text, participant attributes, and prompt templates.
Output: Prompt sentences instructing a generative AI model to generate performance summaries and improvement proposals.
Step 14
The server interacts with the generative AI model to obtain improvement proposals.
The server sends the constructed prompt sentence to a generative AI model via an application programming interface, and the generative AI model returns generated text representing improvement-proposal information. The server receives the generated text, parses it if needed into sections such as summary, training recommendations, and tactical advice, and validates basic properties such as length and presence of expected sections. The server then stores the improvement-proposal information in association with the underlying motion-index information and ability-evaluation information.
Input: Prompt sentences constructed by the server.
Output: Improvement-proposal information obtained from the generative AI model and stored in structured form.
Step 15
The terminal collects and transmits condition information.
The user operates the terminal to input condition information, such as physical-state details and lifestyle details, through forms or selection interfaces. The terminal validates the input format and associates the condition information with existing participant and match identifiers. The terminal serializes the condition information into a structured representation and sends it to the server via a secure network request.
Input: User-entered condition information and identifiers of participants and matches.
Output: A network request containing structured condition information transmitted to the server.
Step 16
The server integrates condition information into individual-state information.
The server receives the condition information, links it to the corresponding participants and matches in the database, and combines it with existing motion-index information and ability-evaluation information. The server creates a unified representation of each participant's state that includes, for example, measures of fatigue, sleep duration, training frequency, and key motion indices and scores. The server stores this integrated individual-state information as a structured record for later prompt construction.
Input: Condition information and previously stored motion-index and ability-evaluation information.
Output: Individual-state information combining physical-state, lifestyle, and performance-related data for each participant.
Step 17
The server generates condition-aware prompt sentences.
The server retrieves individual-state information and uses a dedicated text template that instructs the generative AI model to produce training plans and nutritional advice tailored to that information. The server fills the template with values such as age, weekly schedule, fatigue indicators, and key performance metrics and composes a prompt sentence that explicitly specifies the output requirements, including format and tone. The server records these prompt sentences for subsequent calls to the generative AI model.
Input: Individual-state information and condition-aware prompt templates.
Output: Condition-aware prompt sentences instructing the generative AI model to generate training-plan and nutrition-advice information.
Step 18
The server obtains training-plan and nutrition-advice information from the generative AI model.
The server provides the condition-aware prompt sentence to the generative AI model through an interface, receives the corresponding generated text, and identifies segments describing training plans and nutritional recommendations. The server structures the text into fields, such as daily guidelines, pre-activity meals, and post-activity recovery snacks, and links the structured information to each participant's record in the database.
Input: Condition-aware prompt sentences.
Output: Training-plan information and nutrition-advice information generated by the generative AI model and stored per participant.
Step 19
The server optionally incorporates emotion information and generates emotion-aware prompt sentences.
When emotion data is available, the terminal captures or forwards user voice information, image information, or operation information to the server. The server executes emotion-estimation processing on the received data using an emotion-estimation model, outputs emotion labels or scores, and associates them with the participant's motion-index information and ability-evaluation information to create emotion-added state information. The server then uses an emotion-aware prompt template to generate a prompt sentence that includes both performance and emotion context and instructs the generative AI model to provide advice that considers emotional state.
Input: User-related information (voice, image, or operation) and existing performance data.
Output: Emotion labels or scores, emotion-added state information, and emotion-aware prompt sentences.
Step 20
The server generates emotion-responsive advice using the generative AI model.
The server sends the emotion-aware prompt sentence to the generative AI model, receives generated text describing performance evaluation and improvement proposals tailored to the detected emotional state, and parses it into advice segments. The server stores the emotion-responsive advice information in association with the participant's other data and marks it as emotion-sensitive content for selective display.
Input: Emotion-aware prompt sentences derived from emotion-added state information.
Output: Emotion-responsive advice information generated by the generative AI model.
Step 21
The server compiles and formats output data for the terminal.
The server gathers all relevant information for each participant, including motion-index information, ability-evaluation information, improvement-proposal information, training-plan information, nutrition-advice information, and, when present, emotion-responsive advice.
The server organizes this information into a response structure, optionally adds derived indicators or summaries, and formats the data into a representation such as structured text or structured fields for display.
Input: All stored information related to a participant and a selected activity.
Output: Combined output data prepared for transmission to the terminal.
Step 22
The terminal retrieves and displays the analysis and advice.
The user operates the terminal to select a match or participant from a list. The terminal sends a request for the corresponding analysis and advice to the server, receives the combined output data, and renders the contents on the display. The terminal presents numeric statistics, textual explanations, and generative AI outputs in an organized layout, enabling the user to review performance, recommended training, and nutritional guidance and to act on the recommendations.
Input: User selection input and combined output data received from the server.
Output: Displayed analysis and advice on the terminal screen, available for user review and use.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented analysis systems that process video or sensor data for performance evaluation suffer from several technical limitations. First, such systems typically perform fixed, rule-based analysis pipelines that output static metrics, and they require human experts to manually interpret those metrics and derive concrete improvement actions. As a result, the overall processing pipeline from data acquisition to actionable guidance is fragmented, latency is high, and computing resources are not effectively utilized. Second, conventional systems are not designed to systematically transform low-level feature data into structured, machine-understandable instructions for a downstream generative artificial intelligence model. In many cases, unstructured or ad hoc text is provided to the model, leading to non-deterministic behavior, redundant computation, and inconsistent output quality. The absence of a standardized mechanism for constructing prompt sentences from internal feature representations prevents the system from taking full advantage of generative artificial intelligence capabilities and makes it difficult to reliably automate the generation of detailed action plans.
Third, conventional systems generally do not integrate heterogeneous data types such as time-series motion features, evaluation scores, and emotion information from users into a unified representation that can be consumed by a generative artificial intelligence model. This lack of integration results in underutilization of available data, prevents accurate modeling of subject state, and limits the system's ability to generate context-aware recommendations. As a consequence, system-level performance, including throughput of analysis, adaptability of generated plans, and the relevance of feedback, is degraded.
Fourth, in known architectures, the coupling between analysis modules and user-facing recommendation modules is often rigid and monolithic. Changes in analysis logic or in the format of recommendations tend to require extensive manual redesign and redeployment, which leads to reduced maintainability and scalability. Furthermore, because the generation of recommendations is not treated as a first-class computational step driven by internal data structures, the system cannot dynamically optimize prompt content or scheduling based on current computational load or data quality.
Accordingly, there is a need for an improved computer-implemented system that (i) systematically acquires image information, (ii) extracts and aggregates motion-based feature data, (iii) performs automated evaluation of subjects, (iv) constructs structured prompt sentences for a generative artificial intelligence model based on internal feature and evaluation data, and (v) integrates emotion information where available, so that actionable plans can be generated in a consistent, scalable, and resource-efficient manner. Such a system should improve the overall computer technology by structuring the data flow from low-level image information to high-level generative output, reducing human intervention, and enabling more efficient and reliable utilization of computational resources and generative artificial intelligence models.

The specific processing by the specific processing unit 290 of the data processing device 12 in Application Example 2 is realized by the following means.

The present invention provides a server comprising a processor configured to acquire image information including motion of a subject from at least one input device, automatically analyze the acquired image information to extract motion information for each subject, aggregate the extracted motion information on a time basis and store the aggregated motion information as feature data in a storage, evaluate at least one of work efficiency, physical performance, and safety of each subject based on the stored feature data, generate a prompt sentence for input to a generative artificial intelligence model based on the feature data and a result of the evaluation, the prompt sentence instructing the generative artificial intelligence model to generate an improvement proposal, and output the improvement proposal acquired from the generative artificial intelligence model as at least one of a behavior plan, a work plan, and a training plan for each subject, and optionally further configured to monitor state information of each subject, to acquire emotion information of a user by using an emotion estimation function, and to incorporate the state information and the emotion information into the generated prompt sentence. This enables the server to implement an integrated and technically structured processing pipeline that converts raw image information into time-series feature data, performs automated evaluation at the processor level, and programmatically constructs machine-targeted prompt sentences for a generative artificial intelligence model, thereby improving the efficiency, scalability, and consistency of computer-based analysis and recommendation generation, reducing reliance on manual expert intervention, and enhancing utilization of computational and storage resources in generating context-aware improvement proposals.

The term “processor” refers to a hardware or virtual computing element, such as a central processing unit or an execution core, that executes machine-readable instructions to perform data acquisition, analysis, and control operations within the system.
The term “image information” refers to digital data representing visual content, including still images or video frames, that is captured by an input device and includes at least one representation of motion of a subject over time.
The term “subject” refers to any target entity whose motion or behavior is to be analyzed by the system, including a human operator, an athlete, a machine, a robot, or any other object exhibiting observable motion.
The term “motion information” refers to data derived from image information that characterizes movement of a subject, including at least one of position, velocity, direction, acceleration, posture, trajectory, or frequency of movement.
The term “time basis” refers to a temporal framework in which motion information is organized or aggregated, including a discrete time interval, a frame index, a time stamp, or any other temporal segmentation applicable to the image information.
The term “feature data” refers to structured data obtained by processing and aggregating motion information, the structured data representing quantitative or qualitative characteristics of a subject's motion over time for use in subsequent evaluation or analysis.
The term “storage” refers to any physical or logical data retention component, including volatile memory, non-volatile memory, and external storage systems, that stores feature data, evaluation results, prompt sentences, or improvement proposals for later retrieval and processing.
The term “work efficiency” refers to a measure of how effectively a subject performs a work-related task, the measure being based on at least one parameter such as task completion time, idle time, energy expenditure, or number of unnecessary motions.
The term “physical performance” refers to a measure of the physical capabilities or activity level of a subject, including at least one of running distance, number of sprints, speed, endurance, strength metrics, or coordination metrics.
The term “safety” refers to a degree of risk associated with a subject's motion or environment, including likelihood of injury, rule violations, proximity to hazardous zones, or occurrence of unsafe postures or behaviors.
The term “evaluation” refers to a computational process performed by the processor to determine one or more scores, classifications, or indicators that quantify or categorize at least one of work efficiency, physical performance, and safety based on feature data.
The term “prompt sentence” refers to a text sequence generated by the processor that encodes structured instructions and contextual information for input to a generative artificial intelligence model, the text sequence specifying at least one type of analysis or proposal to be generated.
The term “generative artificial intelligence model” refers to a machine learning model that, in response to an input including a prompt sentence and optionally structured data, generates new output content such as natural language text, the output content including at least one of an analysis or an improvement proposal.
The term “improvement proposal” refers to information generated based on evaluation results and optionally emotion information that specifies one or more recommended changes to behavior, work processes, or training in order to enhance at least one of work efficiency, physical performance, and safety.
The term “behavior plan” refers to a structured set of recommended actions or motion patterns for a subject to follow in a given context, including sequence, timing, and conditions for performing specific behaviors.
The term “work plan” refers to a structured description of work-related tasks, schedules, or procedures assigned to a subject, including task allocation, order of operations, and suggested modifications for improving efficiency or safety.
The term “training plan” refers to a structured program of exercises or practice activities designed to improve physical performance or skill of a subject over a period of time, including frequency, intensity, type, and progression of training sessions.
The term “state information” refers to data representing a condition of a subject, including at least one of fatigue level, workload, physical condition, performance trend, or contextual status derived from evaluation results or additional sensors.
The term “nutritional guidance” refers to recommendations generated for a subject regarding intake of food or nutrients, including at least one of quantity, timing, composition, or balance of nutrients to support performance, recovery, or health.
The term “emotion information” refers to data representing an estimated emotional state of a user or subject, the data being derived from at least one of facial expressions, voice characteristics, physiological signals, or behavioral patterns.
The term “emotion estimation function” refers to a software-implemented or hardware-implemented function that analyzes input data such as image, audio, or sensor data to estimate probabilities or scores corresponding to one or more emotional states.
The term “performance analysis” refers to an assessment generated by processing feature data, evaluation results, and optionally emotion information, the assessment describing strengths, weaknesses, trends, and critical points of a subject's behavior or activity.
The term “rest proposal” refers to a recommendation specifying when and how a subject should interrupt activity to rest or recover, including rest timing, duration, and frequency, based on at least one of evaluation results and emotion information.
The term “work-environment improvement proposal” refers to a recommendation specifying one or more changes to a physical or operational environment, such as layout, lighting, noise level, or task allocation, for the purpose of improving comfort, safety, or efficiency of subjects.
The term “user” refers to a person who interacts with the system, including an operator, a coach, an administrator, or a subject who receives recommendations, and who may provide data such as video, feedback, or configuration settings to the system.

In one embodiment, a server, a terminal, and a user cooperate to implement the claimed system. The server comprises at least one processor, a memory, a non-transitory storage device, and a communication interface. The terminal comprises an imaging device such as a camera or an image sensor, a display, a user input interface, and a communication module. The user operates the terminal to capture image information and to review recommendations generated by the server.
The server executes a program stored in the memory. The program includes modules for image acquisition, motion feature extraction, feature aggregation, evaluation, state monitoring, emotion estimation integration, prompt sentence generation, communication with a generative AI model, and recommendation management. The server uses a general-purpose computing platform such as a multi-core processor, a graphics processing unit, and a network adapter. In an example, the server uses a software stack including an operating system, a database management system, a numerical computation library, a machine learning framework, and an HTTP server framework. The server, for example, uses a relational database system for storing feature data and evaluation results, uses a file or object storage system for storing videos or image sequences, and uses a network communication library for interacting with external AI services.
The terminal captures image information including motion of a subject by using an imaging device. The terminal encodes the captured image information into a compressed video stream or a sequence of still images and transmits the encoded data to the server via a communication network. The user may select a recording mode suitable for a particular environment, such as a factory environment or a sports field.
The server receives the image information from the terminal via the communication interface. The server decodes the received video stream into individual frames and stores the frames in a frame buffer in the memory. The server associates each frame with a timestamp, a camera identifier, and optionally a subject group identifier. The server uses a library for video decoding and frame access, such as a software library for handling multimedia data.
The server performs motion feature extraction from the frames by using an image processing and computer vision library such as an open-source image processing library and a machine learning framework such as a tensor computation framework. The server converts each frame into a normalized format (e.g., fixed resolution, color space normalization) and applies a convolutional neural network based object detector. The detector may be based on a region-based architecture, a single-shot detector, or a transformer-based detector. The network architecture may include multiple convolutional layers, batch normalization layers, non-linear activation layers, and pooling layers. The detector outputs bounding boxes and class scores for detected subjects in each frame.
The server tracks subjects across frames by using a tracking algorithm such as a Kalman filter combined with an association algorithm or a deep feature-based multi-object tracker. The server maintains an identifier for each tracked subject and a time series of positions for each subject. Based on these positions and timestamps, the server computes motion information including position vectors, velocity vectors, acceleration, direction of movement, and trajectory curvature. The server also computes higher-level motion statistics such as the number of rapid accelerations, time spent in specific spatial zones, and frequency of posture changes.
The server aggregates the motion information on a time basis. The server, for example, divides the timeline into fixed-length intervals and computes aggregated statistics per subject for each interval, such as average speed, maximum speed, distance covered, number of stops, and time in risky regions. The server stores these aggregated statistics as feature data in structured records in the storage device. Each record includes a subject identifier, a time interval identifier, and a set of numerical feature values.
The server evaluates at least one of work efficiency, physical performance, and safety of each subject based on the stored feature data. The server loads feature vectors from the database into memory and normalizes them by using a precomputed mean and variance or a min-max scaling scheme. The server then inputs the normalized vectors into a trained evaluation model. In one embodiment, the evaluation model is a neural network having an input layer corresponding to the feature dimensions, several hidden layers, and an output layer producing scores for different evaluation categories. The hidden layers may include fully connected layers with non-linear activation functions such as rectified linear units, and may include dropout layers for regularization. The server computes evaluation scores such as an efficiency score, a fatigue score, a safety risk score, and a stability score for each subject.
The server trains the evaluation model in advance using supervised learning. During training, the server uses a training dataset containing feature vectors paired with ground truth labels or scores provided by expert annotations or by historical outcomes. The server defines a loss function such as a mean squared error for regression or a cross-entropy loss for classification and updates model parameters using a gradient-based optimization algorithm such as stochastic gradient descent or an adaptive moment estimation method. The server may perform data augmentation at the feature level by adding noise, scaling features, or simulating different speed profiles to improve robustness. The server stores the trained model parameters in the storage device and loads them into memory at runtime.
The server optionally monitors state information of each subject by combining multiple evaluation results over time. The server, for example, computes sliding-window averages of efficiency scores, detects trends in fatigue scores, and identifies anomalies such as sudden drops in performance. The server stores the state information as additional records linked to the subject and time interval.
The server optionally acquires emotion information of a user or a subject. In one embodiment, the terminal captures close-up images of a face, and the server sends the images to an emotion estimation function, which may be an internal neural network or an external emotion estimation service. The emotion estimation function analyzes facial landmarks, expression features, or temporal changes and outputs probabilities for emotional states such as happiness, stress, frustration, or fatigue. The server aggregates emotion probabilities over time and associates them with the corresponding subject identifiers and time intervals in the storage device.
The server constructs prompt sentences for a generative AI model by using the feature data, the evaluation results, the state information, and optionally the emotion information. The server uses a prompt generation module that transforms internal structured data into natural language text. The module may use templates with placeholders for key metrics and indicators. For example, the server generates a prompt sentence such as:
“You are an industrial process optimization assistant. Based on the following data for a particular machine and a particular worker (cycle time trend, idle time, afternoon slowdown, and emotion scores indicating fatigue), generate a prioritized list of concrete actions to improve throughput and safety. Include maintenance steps, layout changes, and rest-break recommendations.”
In another example, the server generates a prompt sentence such as:
“You are a professional sports performance coach. Using a player's match metrics (distance, sprints, pass success, shots, second-half decline) and emotion data (fatigue and frustration after 60 minutes), generate a 4-week training plan, detailed nutrition guidance, and mental support techniques.”
The server may use a rule-based system or a lightweight natural language generation model to select which elements of feature data and evaluation results to include in the prompt and how to phrase them. The selection may depend on whether efficiency, safety, stamina, or another dimension is most critical for the subject during a specific time period. This targeted composition of the prompt sentences improves the quality and consistency of interaction with the generative AI model and reduces unnecessary token usage, thereby reducing computation time and communication load.
The server sends the generated prompt sentence to a generative AI model via a network interface. The generative AI model may be executed on the same server or on a remote computing service. The generative AI model may be a large language model based on a transformer architecture. The model may include an encoder-decoder structure or a decoder-only structure with multiple attention layers, feed-forward layers, and layer normalization. The model parameters are trained on large-scale text data and optionally fine-tuned on domain-specific prompt-response pairs related to performance optimization and planning. The server configures parameters for the generative AI model call, such as a temperature parameter for controlling variation, a maximum output length, and a penalty parameter for repetition. The server transmits the prompt sentence as input and receives an output text containing an improvement proposal. The improvement proposal may comprise a list of recommended actions, a schedule of training or work sessions, a set of maintenance steps, or nutritional guidance expressed in natural language.
The server parses the received improvement proposal text and stores it in the storage device, linked to the corresponding subject and time interval. The server may also post-process the proposal by extracting structured elements, such as dates, frequencies, or thresholds, by using a lightweight parser or pattern-matching functions. The server then prepares a response for the terminal containing the improvement proposal in a display-friendly format such as a structured document.
The terminal receives the improvement proposal from the server, displays it on the screen to the user, and may allow the user to interact with it. The user may accept, reject, or modify specific recommendations. The terminal sends user feedback to the server, which stores the feedback and may use it to adjust future prompt generation logic. Over time, the system may adapt to user preferences and improve the match between generated recommendations and real-world constraints.
This architecture improves computer technology in several ways. The aggregation of motion information as structured feature data enables efficient indexing and retrieval in the database, reducing processing time when new evaluations or prompt sentences are generated. The use of specialized neural network architectures for detection, tracking, and evaluation allows the server to transform high-dimensional image streams into compact feature vectors, reducing bandwidth and storage requirements. The explicit generation of prompt sentences from internal feature and evaluation data creates a standardized interface between deterministic analysis modules and the generative AI model. This separation allows the server to optimize prompt content in a data-driven manner, reducing variance in generative outputs and improving reproducibility.
The integration of emotion information into the prompt sentences enables the generative AI model to generate context-aware proposals that account for user state, which cannot be achieved reliably with traditional static rule-based systems. By combining time-series motion features, evaluation scores, state trends, and emotion probabilities, the server can construct richer prompt sentences that guide the generative AI model to produce more precise and actionable content. This reduces trial-and-error interaction and lowers computational overhead on the generative AI service.
The server uses non-conventional processing flows and decision rules that differ from mere automation of human expert tasks. For example, the server applies anomaly detection on multi-dimensional feature vectors using distance-based or density-based algorithms and automatically switches prompt templates based on detected anomaly type. The server may, for instance, choose a safety-focused prompt template when a safety risk score exceeds a threshold and a stamina-focused template when a fatigue trend is detected. This rule-based template selection is performed at the machine level and leverages internal metrics and evaluation scores that are not directly observable by a human viewer of the raw video.

In another embodiment, the server uses different evaluation models depending on the type of subject. For industrial machines, the evaluation model emphasizes cycle time variability, idle time, and error frequency. For human subjects such as athletes, the evaluation model emphasizes distance, sprint frequency, and event outcomes. The server may dynamically select which evaluation model to use based on metadata associated with the image information, and the server may construct different prompt sentences accordingly. This modular design allows the same hardware and software infrastructure to support multiple use cases while reusing the core feature extraction and prompt generation logic.
In a further embodiment, the server executes the generative AI model locally rather than via a remote service. In such a case, the server loads model weights into local memory and performs inference using hardware acceleration on a graphics processing unit. The server may quantize the model weights to reduce memory footprint and inference time and may batch multiple prompt sentences together to improve throughput. These optimizations result in faster response times and lower power consumption compared to a naive implementation. In another variation, the terminal performs a portion of the processing, such as pre-filtering frames or computing simple motion features, before transmitting data to the server. By offloading part of the computation to the terminal, the system can reduce network bandwidth usage and server load. The server receives pre-processed data and integrates it with server-side analysis. This division of labor can be adapted based on network conditions, terminal capabilities, and server load, improving overall system performance.
By structuring data into feature vectors and evaluation scores, by integrating heterogeneous data types including emotion information, by programmatically generating optimized prompt sentences for a generative AI model, and by implementing non-conventional control flows and selection logic, the system provides a technical improvement in the way computing resources are used to transform raw image information into actionable plans. The system thus goes beyond simple automation of human interpretation and instead modifies the internal functioning of the computer system to achieve improved speed, accuracy, consistency, and resource efficiency in analysis and recommendation generation.

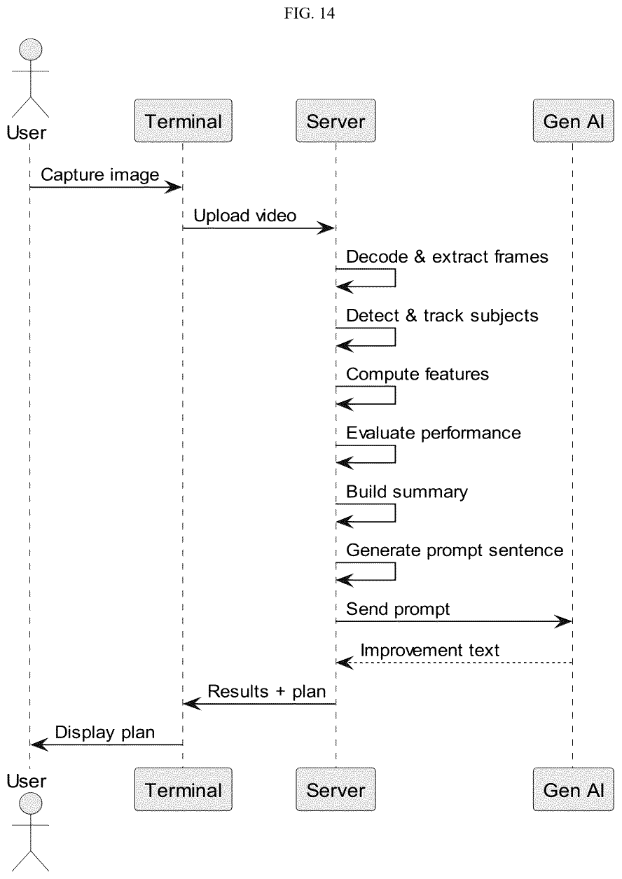

The following describes the processing flow using FIG. 14.
Step 1
User operates the terminal to capture image information including motion of one or more subjects.
Terminal receives raw sensor signals from an imaging device, converts the signals into a digital video stream or a sequence of image frames, and encodes the stream using a compression format.
Input: analog or raw sensor signals from the imaging device.
Output: encoded digital image information (e.g., a video file or image sequence) stored temporarily in the terminal.
Terminal performs sampling, analog-to-digital conversion, frame segmentation, and compression to obtain the encoded digital image information.

### Step 2

User operates the terminal to select the encoded image information and to initiate an upload operation.
Terminal establishes a network connection to the server, divides the encoded image information into data packets, and transmits the packets to the server via a communication protocol.
Input: encoded digital image information stored on the terminal.
Output: a stream of data packets containing the image information transmitted to the server.
Terminal performs packetization, header attachment, and error detection coding so that the server can reconstruct the original image information.
Step 3
Server receives the data packets from the terminal, reconstructs the encoded image information, and stores it in a storage device.
Server verifies packet integrity, reorders packets if necessary, and writes the reconstructed video file or image sequence to a non-transitory storage medium, while also creating metadata records.
Input: data packets containing the image information.
Output: decoded video file or image sequence stored in server storage, plus metadata entries including file path, timestamps, and identifiers.
Server performs de-packetization, checksum verification, and file creation operations to obtain a persistent representation of the image information.
Step 4
Server decodes the stored video file or image sequence into individual frames and prepares the frames for analysis.
Server loads the file from storage, uses a multimedia processing library to extract frames, converts frames to a normalized resolution and color space, and stores them in a frame buffer in memory.
Input: encoded video file or image sequence stored in server storage.
Output: a sequence of normalized image frames stored in a frame buffer in memory.
Server performs decompression, resizing, color conversion, and frame indexing to generate a structured sequence of frames with associated timestamps.
Step 5
Server detects subjects in each frame and extracts motion information.
Server applies an object detection neural network to each frame, obtains bounding boxes and class scores, and associates detected regions with subject identifiers via a tracking algorithm.
Input: sequence of normalized image frames in the frame buffer.
Output: per-frame detection results including subject identifiers, bounding box coordinates, and detection confidence values.
Server performs convolution, pooling, activation, and non-maximum suppression operations within the neural network, and then performs state estimation and data association operations within the tracking algorithm to derive motion information per subject.
Step 6
Server computes motion features and aggregates them on a time basis to obtain feature data.
Server uses the subject identifiers and bounding box coordinates over multiple frames to calculate positions, velocities, accelerations, and derived statistics such as distance traveled and time spent in defined regions, and then groups these values into fixed time intervals.
Input: per-frame detection and tracking data including subject identifiers and positions.
Output: aggregated feature vectors per subject per time interval stored in a structured data format.
Server performs numerical differentiation, vector arithmetic, temporal averaging, summation, and binning by time intervals to transform raw motion information into compact feature data.
Step 7
Server evaluates at least one of work efficiency, physical performance, and safety for each subject using the feature data.
Server loads feature vectors, normalizes the vectors using stored normalization parameters, and inputs the normalized vectors into a trained evaluation neural network to compute evaluation scores and categories.
Input: aggregated feature vectors per subject per time interval.
Output: evaluation results including numerical scores and classification labels per subject.
Server performs scaling operations on the feature vectors and executes matrix multiplications, bias additions, activation functions, and forward propagation through the evaluation neural network to derive evaluation results.
Step 8
Server monitors state information of each subject based on the evaluation results and identifies trends or anomalies.
Server creates time-series records of evaluation scores, computes moving averages and statistical deviations, and detects conditions such as sustained fatigue or increased safety risk.
Input: evaluation results over multiple time intervals for each subject.
Output: state information records including trend indicators, anomaly flags, and summary statistics per subject.
Server performs time-series aggregation, windowed averaging, comparison against thresholds, and anomaly detection algorithms to determine state information.
Step 9
Server optionally acquires emotion information related to a user or subject and associates this emotion information with feature data and evaluation results.
Server receives additional image or sensor data indicating facial expressions or other emotional cues, applies an emotion estimation function to compute emotion scores, and stores these scores with links to corresponding subjects and time intervals.
Input: additional image or sensor data containing emotional cues, such as facial images.
Output: emotion information including probability distributions over emotional states associated with subjects and time intervals.
Server performs feature extraction for emotional cues, executes an emotion classification model, and records the resulting emotion scores as structured data.
Step 10
Server selects relevant feature data, evaluation results, state information, and emotion information to construct a summary for prompt generation.
Server filters data based on importance (e.g., highest risk scores or largest performance changes), formats numerical values into human-readable statistics, and structures them in an intermediate representation.
Input: stored feature data, evaluation results, state information, and emotion information for a selected subject and time range.
Output: an intermediate summary object containing selected metrics, scores, trends, and emotion indicators.
Server performs data selection, ranking, formatting, and structuring operations to convert raw internal records into a concise representation suitable for natural language generation.
Step 11
Server generates a prompt sentence for a generative AI model based on the intermediate summary.
Server applies a template-based or rule-based natural language generation process, inserting selected metrics and context into predefined sentence structures to form a coherent instruction in natural language.
Input: intermediate summary object describing subject metrics and context.
Output: a prompt sentence in natural language instructing a generative AI model to generate an improvement proposal.
Server performs template selection, placeholder substitution, conditional phrase insertion, and concatenation operations to produce the prompt sentence.
Step 12
Server transmits the prompt sentence to a generative AI model and receives an improvement proposal as output.
Server sends the prompt sentence via a network interface or an internal API call to a generative AI model, sets model parameters such as temperature and maximum output length, and obtains a generated text response containing recommended actions.
Input: prompt sentence constructed from internal data.
Output: generated improvement proposal text produced by the generative AI model.
Server performs network communication or local inference invocation, parameter configuration, and response retrieval to obtain the improvement proposal.
Step 13
Server processes the improvement proposal text and stores it in association with the corresponding subject and time interval.
Server parses the generated text to identify structured elements such as action items, schedules, and priority levels, and records them in a recommendation database, while also preserving the original text for display.
Input: improvement proposal text generated by the generative AI model.
Output: structured recommendation records and stored textual descriptions linked to subjects and time intervals.
Server performs text parsing, pattern matching, extraction of temporal expressions and numeric values, and database insertion operations to translate the free-form proposal into a structured internal representation.
Step 14
Server prepares response data containing evaluation results, state information, emotion information, and the improvement proposal for presentation on the terminal.
Server composes a response object including numerical metrics, graphical summary data, and human-readable recommendation text, formatted for efficient transfer and display.
Input: evaluation results, state information, emotion information, and stored recommendation records.
Output: a response object containing display-ready data transmitted to the terminal.
Server performs data serialization, formatting, and packaging operations to bundle different data types into a unified response.
Step 15
Terminal receives the response object from the server and renders the contents for the user.
Terminal parses the received data, populates user interface elements such as tables, charts, and text areas, and displays behavior plans, work plans, or training plans to the user.
Input: response object transmitted by the server.
Output: visual representation of metrics and improvement proposals on the terminal display.
Terminal performs data deserialization, mapping of values to user interface components, and graphical rendering operations to provide a clear and interactive view to the user.
Step 16
User reviews the displayed evaluation results and improvement proposals and optionally provides feedback or modifications.
User interacts with the terminal interface to accept, reject, or adjust specific items in the behavior plan, work plan, or training plan, and triggers a feedback submission.
Input: visual representation of the server-generated proposals on the terminal.
Output: feedback data or modified recommendation parameters sent from the terminal to the server.
User performs selection and input operations, and the terminal performs encoding and transmission of feedback data, enabling the server to further refine future evaluations and prompt sentence generation.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

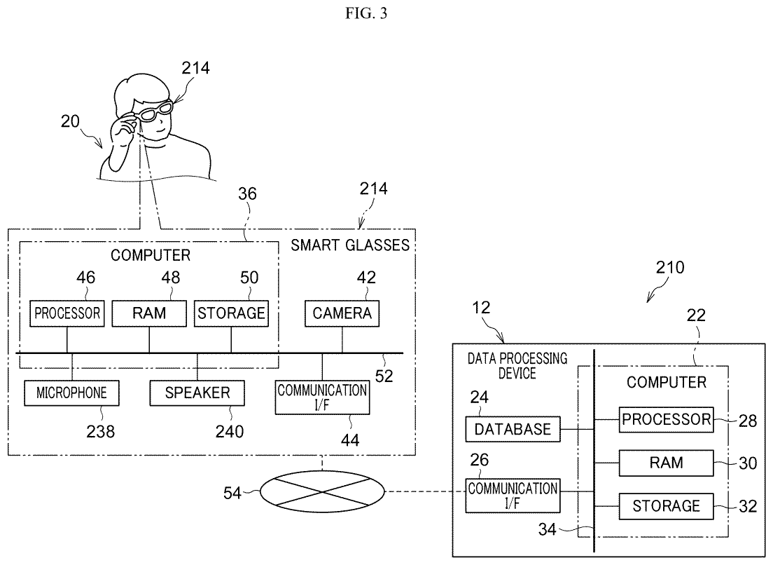

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

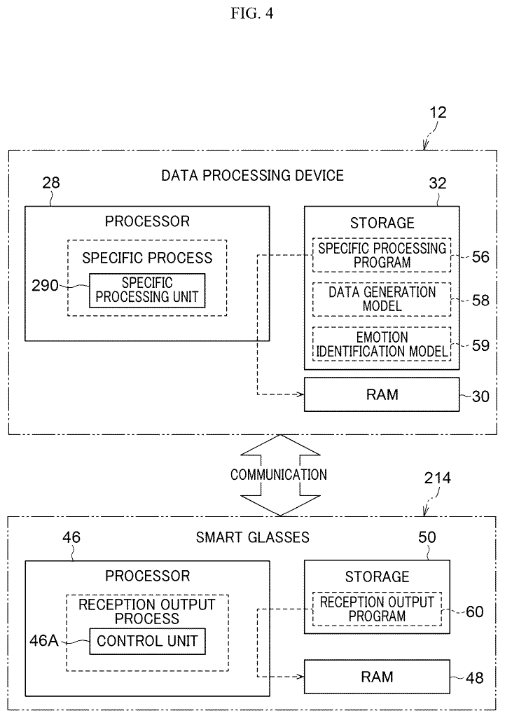

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.
Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

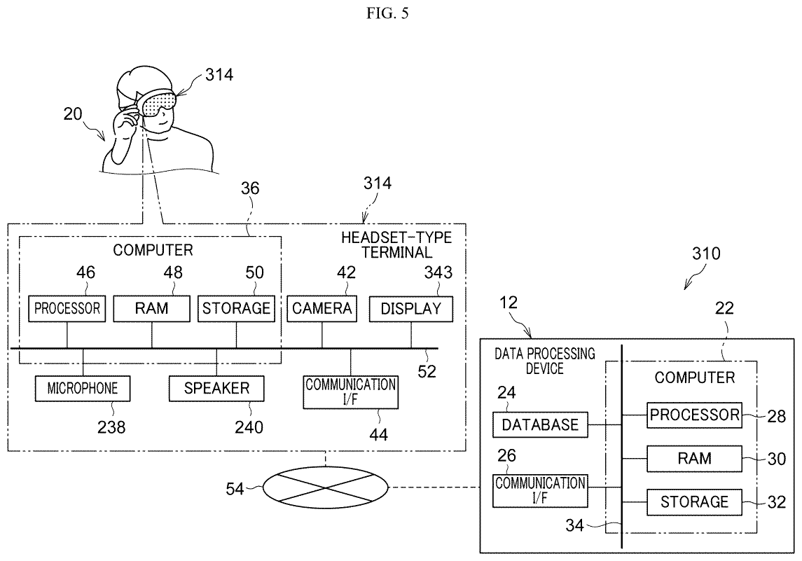

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

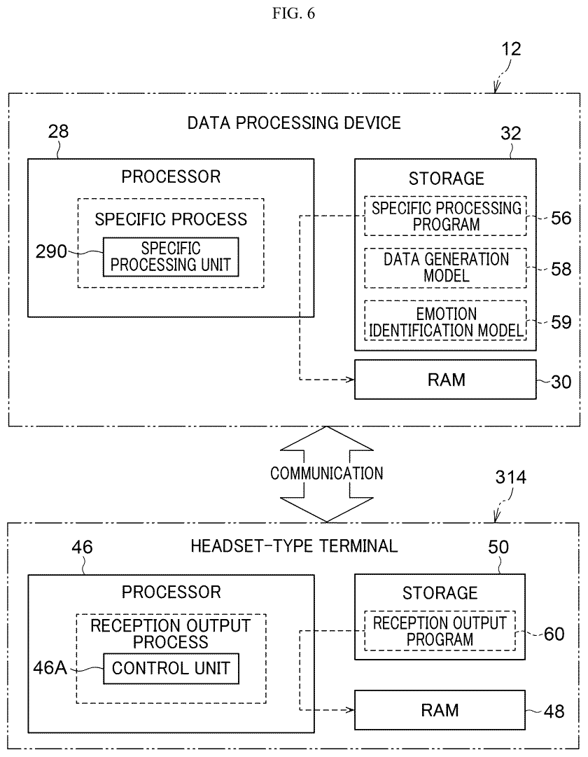

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

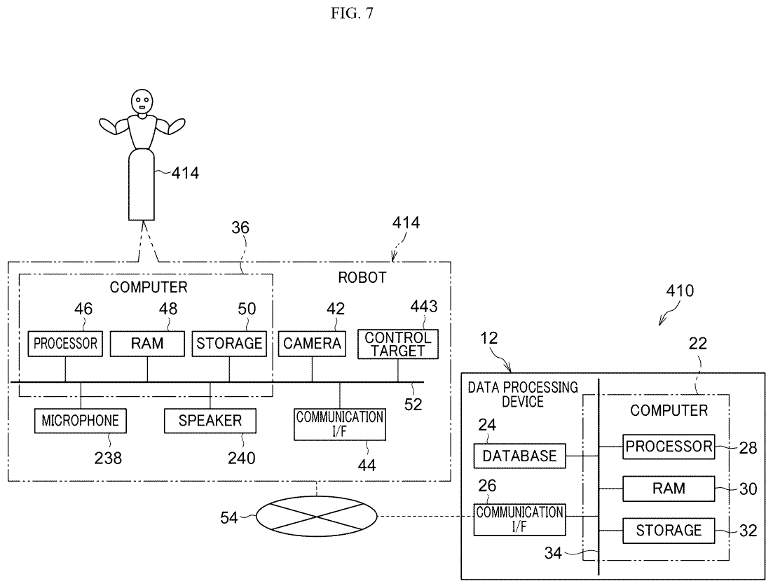

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

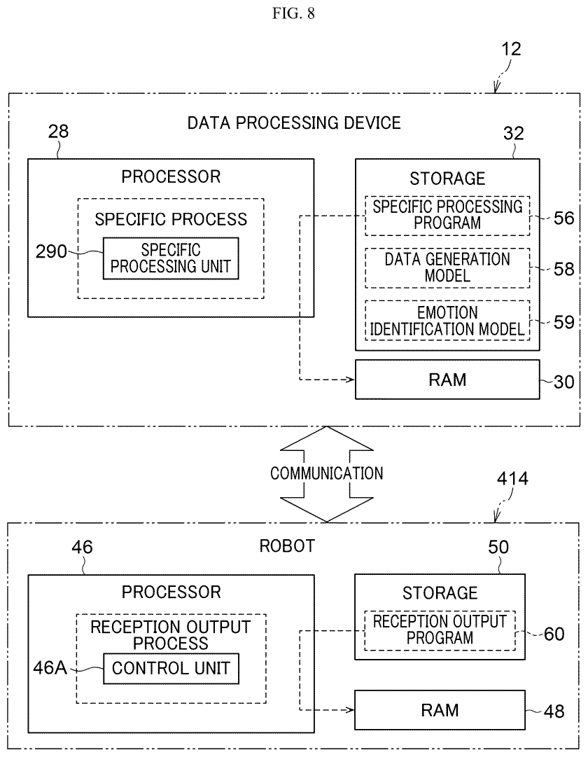

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

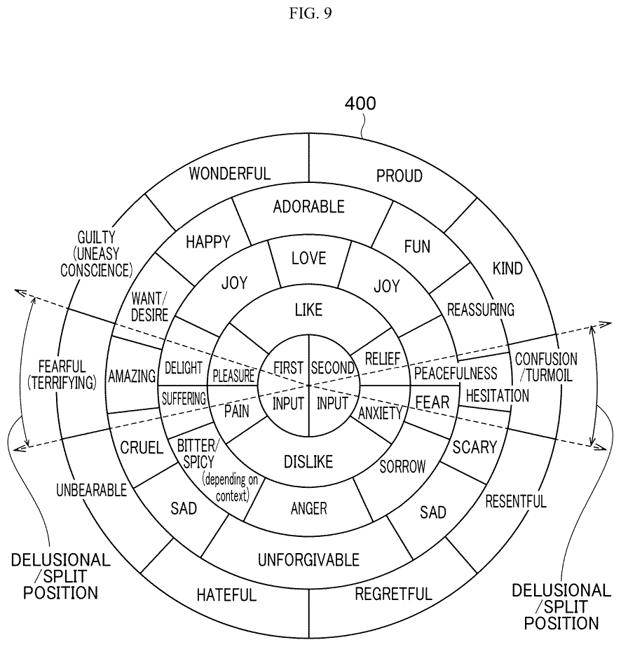

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

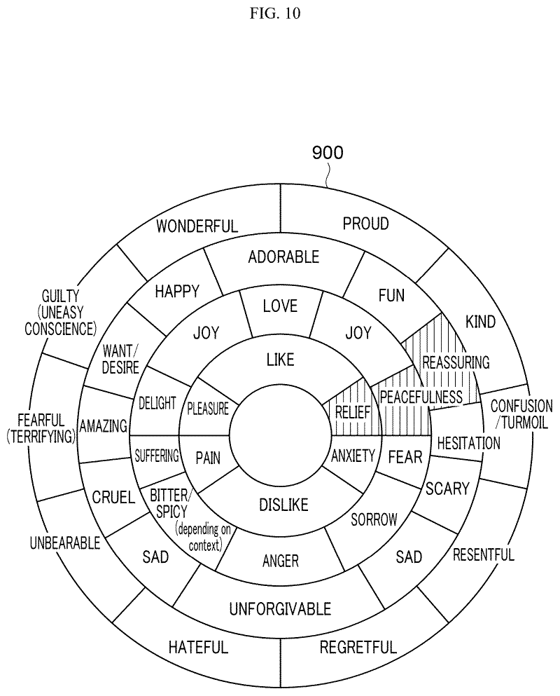

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive moving image data of a soccer match from a terminal and store the moving image data in a storage device,
analyze the stored moving image data by using an image processing program, detect subjects in the moving image data on a frame-by-frame basis, track the subjects over time, generate time-series data of position information of the subjects, and, on the basis of the time-series data, calculate group-level and individual-level motion index data including movement distance, speed, sprint count, and region-wise stay distribution for each subject,
input the motion index data into a machine learning model, execute inference processing by the machine learning model, and generate ability evaluation information including endurance, speed, workload, and tactical contribution for each subject,
generate analysis context information as document data or structured data including feature data, evaluation scores, and temporal changes for each subject by using the ability evaluation information and the motion index data,
generate instruction sentence data as a prompt sentence for input to a generative AI model by combining the analysis context information with text input including instruction content relating to coaching or analysis of soccer,
transmit the instruction sentence data to the generative AI model and acquire improvement proposal information including a training plan, tactical advice, and nutrition guidance based on the ability evaluation information and the motion index data from the generative AI model, and
convert the improvement proposal information into display data divided for each subject or for each group and transmit the display data to the terminal.

### Supplementary 2

The system according to supplementary 1,
wherein the processor is configured to generate, as the instruction sentence data for input to the generative AI model, a prompt sentence that is generated by acquiring state information of each subject obtained from biological information, exercise load information, or performance indices per match, adding the state information to the analysis context information, and including instruction content that instructs generation of a training plan and a nutrition intake plan in which a period, a frequency, and an intensity are adjusted for each subject.

### Supplementary 3

The System According to supplementary 1,
wherein the processor is configured to generate, as the instruction sentence data for input to the generative AI model, a prompt sentence that is generated by acquiring emotional state information calculated from a user's voice input, facial expression information, or operation history, associating the emotional state information with the analysis context information, and including instruction content that instructs changing a presentation method of performance analysis results and contents of the improvement proposal information in accordance with the user's emotional state.

### Application Example 1

### Supplementary 1

A system comprising a processor,
wherein the processor is configured to acquire operation image data and operation-related data,
analyze the operation image data by using an image processing program to generate operation feature data for each work target apparatus,
convert the operation feature data and the operation-related data into a time-series data structure and format the time-series data structure as input data for a generative AI model,
generate a prompt sentence associated with the input data and input the prompt sentence and the input data to the generative AI model,
cause the generative AI model to perform comparison computation between the input data and a reference operation pattern and output an efficiency index and an abnormality determination result,
generate an optimized operation plan including at least one of an operation path, a speed, an acceleration, and a waiting time based on the efficiency index and the abnormality determination result,
generate an improvement proposal sentence expressed in natural language corresponding to the optimized operation plan, and
output the efficiency index, the abnormality determination result, the optimized operation plan, and the improvement proposal sentence to an external device.

### Supplementary 2

The system according to supplementary 1,
wherein the processor is configured to add an additional condition sentence input by a user to the prompt sentence for the generative AI model, and cause the generative AI model to regenerate the optimized operation plan including constraint conditions that prioritize at least one of safety, maintainability, and quality based on the additional condition sentence.

### Supplementary 3

The system according to supplementary 1,
wherein the processor is configured to calculate a load history index of a component by using the operation feature data and accumulated operation-related data, cause the generative AI model to perform degradation state estimation and remaining life estimation based on the load history index, and generate a maintenance proposal sentence regarding a maintenance execution timing and maintenance contents according to a result of the degradation state estimation and the remaining life estimation.

### Example 2

### Supplementary 1

A system comprising a processor,
wherein the processor is configured to control a communication terminal to transfer motion-sport-related video information to an information processing apparatus,
input the video information into image-processing software or machine-learning software, convert the video information into time-series still-image information, extract position information of sport participants and sport equipment for each frame by object-detection processing and tracking processing, and transform the position information into a coordinate system on a playing field to generate movement-trajectory information for each sport participant,
calculate, for each sport participant, motion-index information including running distance, speed, frequency of acceleration actions, and success rate of technical actions on the basis of the movement-trajectory information and the position information of the sport equipment, and input the motion-index information as feature data into a statistical-learning model or a machine-learning model to output ability-evaluation information for each sport participant, convert the motion-index information and the ability-evaluation information into explanatory text in natural language, and automatically generate a prompt sentence including the explanatory text, the prompt sentence instructing a generative AI model to create a performance summary and improvement content for each sport participant, and
input the prompt sentence into the generative AI model, obtain improvement-proposal information including training content and tactical advice for each sport participant from the generative AI model, and associate and store the improvement-proposal information with the motion-index information and the ability-evaluation information and configure them as output data.

### Supplementary 2

The system according to supplementary 1,
wherein the processor is configured to acquire condition information including physical-state information or lifestyle information from the communication terminal, generate individual-state information obtained by integrating the condition information with the motion-index information and the ability-evaluation information, automatically generate a prompt sentence including the individual-state information, the prompt sentence instructing the generative AI model to propose a training plan and nutritional intake content for each sport participant, input the prompt sentence into the generative AI model, and configure training-plan information and nutrition-advice information obtained from the generative AI model as output data.

### Supplementary 3

The system according to supplementary 1,
wherein the processor is configured to use emotion-estimation software that performs emotion-estimation processing based on user voice information, image information, or operation information to acquire emotion information, generate emotion-added state information obtained by associating the emotion information with the motion-index information and the ability-evaluation information,
automatically generate a prompt sentence including the emotion-added state information, the prompt sentence instructing the generative AI model to create performance evaluation and improvement proposals that take the emotion into account, input the prompt sentence into the generative AI model, and configure advice information responsive to the emotion obtained from the generative AI model as output data.

### Application Example 2

### Supplementary 1

A system comprising a processor,
wherein the processor is configured to acquire image information including motion of a subject,
automatically analyze the acquired image information to extract motion information for each subject,
aggregate the extracted motion information on a time basis and store the aggregated motion information as feature data in a storage,
evaluate at least one of work efficiency, physical performance, and safety of each subject based on the stored feature data,
generate a prompt sentence for input to a generative artificial intelligence model based on the feature data and a result of the evaluation, the prompt sentence instructing the generative artificial intelligence model to generate an improvement proposal, and
output the improvement proposal acquired from the generative artificial intelligence model as at least one of a behavior plan, a work plan, and a training plan for each subject.

### Supplementary 2

The system according to supplementary 1,
wherein the processor is configured to monitor state information of each subject based on the result of the evaluation,
and generate a prompt sentence for input to the generative artificial intelligence model according to the state information and the feature data, the prompt sentence instructing the generative artificial intelligence model to generate, for each subject, at least one of a customized training plan, a customized work plan, and customized nutritional guidance.

### Supplementary 3

The system according to supplementary 1,
wherein the processor is configured to acquire emotion information of a user by using an emotion estimation function that estimates an emotional state of the user,
associate the emotion information with at least one of the feature data and the result of the evaluation,
and generate a prompt sentence for input to the generative artificial intelligence model based on the emotion information and at least one of the feature data and the result of the evaluation, the prompt sentence instructing the generative artificial intelligence model to generate at least one of a performance analysis, an improvement proposal taking into account the emotional state, a rest proposal, and a work-environment improvement proposal.

What is claimed is:

1. A system comprising:
circuitry configured to:
receive moving image data from a terminal apparatus via a packet-switched network and store the moving image data in a storage medium;
analyze the moving image data by applying an image processing algorithm to detect subjects in the moving image data on a frame-by-frame basis and track the subjects over successive frames to generate time-series position data for each detected subject;
compute motion index data for each subject based on the time-series position data, the motion index data including movement distance values, velocity values, acceleration event counts, and region-wise distribution values;
construct a parameterized instruction sequence based on the motion index data, the parameterized instruction sequence specifying an analysis task for a generative neural network model; and
provide the parameterized instruction sequence to the generative neural network model to cause the generative neural network model to generate structured output data comprising evaluation information and optimization proposal data for each subject.

2. The system according to claim 1, wherein the image processing algorithm comprises an object detection model that processes each frame to generate bounding box coordinates and classification labels for detected subjects, and a tracking algorithm that associates detected subjects across successive frames based on spatial proximity and appearance feature similarity to maintain subject identity over time.

3. The system according to claim 2, wherein the object detection model comprises a convolutional neural network having a plurality of convolutional layers, pooling layers, and fully connected layers, trained using annotated image data with a loss function comprising a localization loss component and a classification loss component.

4. The system according to claim 3, wherein the circuitry is further configured to:
compute the velocity values by calculating displacement magnitudes between consecutive frame positions divided by frame interval durations, detect acceleration events by identifying velocity changes exceeding a predetermined acceleration threshold over a predetermined time window, and compute the region-wise distribution values by partitioning a spatial coordinate space into a grid of predetermined regions and accumulating frame counts for each subject within each region.

5. The system according to claim 4, wherein the circuitry is further configured to:
input the motion index data into a trained inference model to generate ability evaluation data for each subject, the ability evaluation data including endurance index values, speed index values, workload index values, and positional contribution index values.

6. The system according to claim 5, wherein the trained inference model comprises a neural network having an input layer corresponding to dimensions of the motion index data, one or more hidden layers with non-linear activation functions, and an output layer that computes the ability evaluation data, the neural network trained using historical motion index data and corresponding labeled evaluation data.

7. The system according to claim 6, wherein the circuitry is further configured to:
generate analysis context data as structured data including feature values, evaluation scores, and temporal change information for each subject based on the ability evaluation data and the motion index data, and incorporate the analysis context data into the parameterized instruction sequence.

8. The system according to claim 7, wherein the parameterized instruction sequence includes instruction content specifying generation of optimization proposal data comprising at least one of an activity plan, tactical adjustment data, and intensity scheduling data based on the ability evaluation data and the motion index data.

9. The system according to claim 8, wherein the circuitry is further configured to:
acquire state information for each subject from at least one of biological sensor data, exercise load data, and performance index data, add the state information to the analysis context data, and include instruction content in the parameterized instruction sequence that specifies generation of a customized activity plan in which period, frequency, and intensity are adjusted for each subject based on the state information.

10. The system according to claim 9, wherein the circuitry is further configured to:
convert the structured output data into display data divided for each subject or for each group of subjects, and transmit the display data to the terminal apparatus via the packet-switched network for visual presentation.

11. The system according to claim 1, wherein the generative neural network model comprises a transformer-based architecture including an embedding layer, a plurality of self-attention layers, feed-forward layers, and normalization layers, and wherein the circuitry provides the parameterized instruction sequence as a token sequence to the transformer-based architecture together with decoding control parameters including a maximum output token count and a sampling temperature value.

12. The system according to claim 11, wherein the circuitry is further configured to:
acquire image data from an imaging device and acoustic data from an acoustic transducer associated with the terminal apparatus, extract visual feature data from the image data using a facial landmark detection algorithm, extract acoustic feature data from the acoustic data, concatenate the visual feature data and the acoustic feature data into a combined feature vector, and apply an emotion estimation model to the combined feature vector to compute emotion classification data.

13. The system according to claim 12, wherein the circuitry is further configured to:
associate the emotion classification data with the analysis context data, and include instruction content in the parameterized instruction sequence that specifies adaptation of a presentation method of evaluation results and contents of the optimization proposal data in accordance with the estimated emotional state.

14. The system according to claim 1, wherein the circuitry is further configured to:
convert the motion index data and associated temporal metadata into a time-series data structure, format the time-series data structure as input data for the generative neural network model, and generate the parameterized instruction sequence to include both the formatted input data and comparison reference pattern data for efficiency analysis.

15. The system according to claim 14, wherein the circuitry is further configured to:
cause the generative neural network model to perform comparison computation between the input data and the comparison reference pattern data to output an efficiency index value and an anomaly determination result for each subject.

16. The system according to claim 15, wherein the circuitry is further configured to:
generate an optimized operation plan including at least one of an activity path specification, a velocity target, an acceleration target, and a rest interval specification based on the efficiency index value and the anomaly determination result.

17. The system according to claim 16, wherein the circuitry is further configured to:
compute a cumulative load history index for each subject based on accumulated motion index data over a plurality of sessions, include the cumulative load history index in the parameterized instruction sequence, and cause the generative neural network model to generate condition estimation data and remaining capacity estimation data based on the cumulative load history index.

18. A system comprising:
circuitry configured to:
receive, via a communication interface coupled to a packet-switched network, moving image data from a terminal apparatus and store the moving image data in a storage medium;
analyze the moving image data by applying an object detection model and a tracking algorithm to detect and track subjects across successive frames, and generate time-series position data and motion index data including movement distance values, velocity values, and acceleration event counts for each subject;
input the motion index data into a trained inference model to generate ability evaluation data for each subject;
construct a parameterized instruction sequence based on the motion index data and the ability evaluation data, and provide the parameterized instruction sequence to a generative neural network model having a transformer-based architecture including a plurality of self-attention layers to generate structured output data comprising optimization proposal data; and
transmit the structured output data to the terminal apparatus via the packet-switched network.

19. The system according to claim 18, wherein the circuitry is further configured to:
acquire emotional state data from facial expression analysis or acoustic analysis associated with an entity operating the terminal apparatus, associate the emotional state data with the ability evaluation data, and adapt the parameterized instruction sequence to cause the generative neural network model to modify the presentation method and content of the optimization proposal data based on the emotional state data.

20. A method performed by circuitry, the method comprising:
receiving moving image data from a terminal apparatus via a packet-switched network and storing the moving image data in a storage medium;
analyzing the moving image data by applying an image processing algorithm to detect subjects in the moving image data on a frame-by-frame basis and tracking the subjects over successive frames to generate time-series position data for each detected subject;
computing motion index data for each subject based on the time-series position data, the motion index data including movement distance values, velocity values, acceleration event counts, and region-wise distribution values;
constructing a parameterized instruction sequence based on the motion index data, the parameterized instruction sequence specifying an analysis task for a generative neural network model; and
providing the parameterized instruction sequence to the generative neural network model to cause the generative neural network model to generate structured output data comprising evaluation information and optimization proposal data for each subject.
